(19) United States
(12) Patent Application Publication
(10) Pub. No.: US 2016/0282742 A1
(43) Pub. Date: Sep. 29, 2016

(54) TWO-COMPONENT DEVELOPER FOR DEVELOPING ELECTROSTATIC LATENT IMAGE

(71) Applicant: Konica Minolta, Inc., Tokyo (JP)

(72) Inventors: Satoshi UCHINO, Tokyo (JP); Shinya OBARA, Tokyo (JP); Kosuke NAKAMURA, Tokyo (JP)

(21) Appl. No.: 15/064,040

(22) Filed: Mar. 8, 2016

(30) Foreign Application Priority Data
Mar. 25, 2015 (JP) 2015-062793

(51) Int. Cl. G03G 9/113; G03G 9/08

(52) U.S. Cl. CPC G03G 9/1133; G03G 9/0819; G03G 9/0827; G03G 9/0821; G03G 9/0823

(57) ABSTRACT

Provided is a two-component developer for developing an electrostatic latent image capable of stably printing a high-quality image.

Disclosed is a two-component developer for developing an electrostatic latent image which contains toner particles and carrier particles having a core particle surface coated with a coating resin, in which a volume average particle size of the toner particles, an average magnetization of the core particle per one particle in an applied magnetic field of 1 kilooersted, a volume average particle size of the carrier particles, a volume resistivity, and an area ratio of the core particles exposed on the carrier particle surface are in a specific range.

### CROSS-REFERENCE TO RELATED APPLICATION

This application is based on Japanese Patent Application No. 2015-062793 filed on Mar. 25, 2015, the contents of which are incorporated herein by reference.

### BACKGROUND

1. Technical Field

The present invention relates to a two-component developer for developing an electrostatic latent image.

2. Description of Related Art

High image quality or high stability has increasingly required in association with the spread of digital printing. In addition, in the field of toners for electrostatic latent image development, a method to decrease the energy required for fixing by lowering the melting temperature or melt viscosity of the binder resin which constitutes the toner or a method to decrease the energy required for fixing by decreasing the amount of toner on the paper has been investigated from the viewpoint of energy saving. Between these, in the former, a crystalline resin is used so that the melt viscosity can be rapidly lowered at a temperature higher than the melting point and can save energy for fixing. In addition, in the latter, the surface area of the toner particles is increased by decreasing the particle size of the toner, and therefore the paper can be concealed with a small amount of toner. Thus, the energy required for fixing can be decreased without lowering the image density. In addition, the reproducibility of fine latent image is also good by making a particle size of the toner small, and it is possible to achieve both energy saving and high image quality.

For example, a two-component developer in which a toner having a small particle size of about from 3 to 10 μm is combined with a carrier is disclosed in JP 2005-181486 A, JP 2004-348029 A, WO 2010/016605 A (US 2010/0143833), JP 2009-169443 A, and JP 2009-192722 A.

### SUMMARY

In recent years, the output demand for graphics and the like has increased and the output of high image density printing has increased. However, there is a problem that the image quality deteriorates when the printing is continuously carried out at a high image density in the technique disclosed in Patent Documents above.

Accordingly, the invention has been made in view of the above circumstances, and an object thereof is to provide a two-component developer for developing an electrostatic latent image capable of stably printing a high-quality image.

In order to achieve at least one of the above-mentioned purposes, the two-component developer for developing an electrostatic latent image which reflects an aspect of the invention is a two-component developer for developing an electrostatic latent image which contains toner particles and carrier particles having the core particle surface coated with a coating resin and in which a volume average particle size of the toner particles is 3.0 μm or more and 5.0 μm or less, an average magnetization of the core particle per one particle in an applied magnetic field of 1 kilooersted is 3.5×10⁻¹⁰ AM²/particle or more and 5.0×10⁻⁹ AM²/particle or less, a volume average particle size of the carrier particles is 15.0 μm or more and 30.0 μm or less, a volume resistivity is 1.0×10⁸ Ω·cm or more and 5.0×10¹⁰ Ω·cm or less, and an area ratio of the core particles exposed on the carrier particle surface is 10.0% or more and 18.0% or less.

### DETAILED DESCRIPTION

Hereinafter, embodiments of the invention will be described. Incidentally, the invention is not limited to the following embodiments.

In the present specification, the term “X to Y” to indicate the range means “X or more and Y or less”, and the operations and the measurement of physical properties and the like are conducted under a condition of room temperature (20 to 25° C.)/relative humidity of from 40 to 50% RH unless otherwise stated.

The two-component developer for developing an electrostatic latent image (hereinafter, the “two-component developer for developing an electrostatic latent image” is also simply referred to as the “two-component developer”) of an embodiment is a two-component developer for developing an electrostatic latent image which contains toner particles and carrier particles having the core particle surface coated with a coating resin and in which a volume average particle size (a volume average particle diameter) of the toner particles is 3.0 μm or more and 5.0 μm or less, an average magnetization of the core particle per one particle in an applied magnetic field of 1 kilooersted is 3.5×10⁻¹⁰ AM²/particle or more and 5.0×10⁻⁹ AM²/particle or less, a volume average particle size of the carrier particles is 15.0 μm or more and 30.0 μm or less, a volume resistivity is 1.0×10⁸ Ω·cm or more and 5.0×10¹⁰ Ω·cm or less, and an area ratio of the core particles exposed on the carrier particle surface is 10.0% or more and 18.0% or less.

It is effective to make the particle size of the toner particles small and make the particle size of the carrier particles in association with this small in order to realize the output of high image density printing as described above. However, there is a problem that the image quality (for example, uneven density, dot reproducibility, and fogging) deteriorates in continuous printing as the particle size of the carrier particles decreases.

On the other hand, the two-component developer of the present embodiment having the configuration as described above makes it possible to suppress the deterioration in initial image quality and image quality in continuous printing and to stably print a high-quality image even in the case of using the toner particles and carrier particles which have a small particle size.

Hereinafter, the configuration of the two-component developer of the invention will be described in more detail.

[Carrier Particles]

The carrier particles according to the present embodiment are those formed by coating the core particle surface with a coating resin. Here, in the present embodiment, the carrier particles have a form in which the core particles in the carrier particles are partly exposed, and thus the coating also includes a state in which the carrier particles are partly coated with the coating resin.

Incidentally, for the measurement of the physical properties (volume average particle size, volume resistivity, and the like) of the carrier particles to be described below, the following treatment for preliminary preparation is conducted in a case where the sample is a developer: the developer, a small amount of neutral detergent, and pure water are added to a beaker and thoroughly blended, and the supernatant is discarded while applying a magnet to the beaker bottom. Pure water is further added thereto and the supernatant is discarded, thereby removing the toner and the neutral detergent and separating only the carrier. The carrier is dried at 40° C. to obtain a simple substance of carrier particles.

<Volume Average Particle Size of Carrier Particles>

The volume average particle size of the carrier particles is 15.0 μm or more and 30.0 μm or less. The image quality after continuous printing deteriorates when the volume average particle size is less than 15.0 μm. This is presumed to be due to the following mechanism. When the volume average particle size of the carrier particles is less than 15.0 μm, the carrier particles are likely to adhere to the electrostatic latent image support (simply referred to as the “electrophotographic photoreceptor” or “photoreceptor”) by centrifugal force, and thereby the electrostatic latent image support is easily damaged. The surface potential of the electrostatic latent image support is lowered due to such damage. The toner is developed on the portion where the surface potential is lowered and fogging is likely to be caused after continuous printing, and thus the GI value decreases. On the other hand, when the volume average particle size of the carrier particles is more than 30.0 μm, the surface area of the carrier particles decreases and the toner particles are not sufficiently charged. For this reason, the image quality at the initial stage and at the time of continuous printing at a high image density deteriorates.

The volume average particle size of the carrier particles is preferably 15.0 μm or more and 28.0 μm or less and more preferably 20.0 μm or more and 25.0 μm or less. Incidentally, as the volume average particle size of the carrier particles, the median diameter (D₅₀) on a volume basis measured by the method to be described later in Examples is adopted.

The volume average particle size of the carrier particles can be controlled by controlling the pulverization condition by the pulverizing device to be described below, a diameter of beads to be used, composition, pulverizing time, classification method, and the like or controlling the volume average particle size of the core particles. The volume average particle size of the core particles can be controlled, for example, by the pulverizing time after calcination. The particle size tends to be small as the pulverizing time increases.

<Volume Resistivity of Carrier Particles>

The volume resistivity according to the invention is the resistance that is dynamically measured under the developing condition by the magnetic brush.

The volume resistivity of the carrier particles is 1.0×10⁸ Ω·cm or more and 5.0×10¹⁰ Ω·cm or less. The image quality after continuous printing deteriorates when the volume resistivity of the carrier particles is less than 1.0×10⁸ Ω·cm. This is presumed to be due to the following mechanism. When the volume resistivity is less than 1.0×10⁸ Ω·cm, the carrier is likely to adhere to the electrostatic latent image support, and thus the electrostatic latent image support is likely to be easily damaged. The surface potential of the electrostatic latent image support is lowered due to such damage. The toner is developed on the portion where the surface potential is lowered and fogging is likely to be caused after continuous printing, and thus GI value decreases.

On the other hand, when the volume resistivity of the carrier particles exceeds 5.0×10¹⁰ Ω·cm, the image quality at the initial stage and after the time of continuous printing deteriorates. It is believed that this is because the current applied to the toner particles decreases in a case where the volume resistivity of the carrier particles exceeds 5×10¹⁰ Ω·cm and thus the developing property at the initial stage and at the time of continuous printing significantly deteriorates.

The volume resistivity of the carrier particles is preferably 1.0×10⁸ Ω·cm or more and 1.0×10¹⁰ Ω·cm or less and more preferably 1.0×10⁸ Ω·cm or more and 6.0×10⁹ Ω·cm or less.

Incidentally, the volume resistivity can be specifically measured by the method to be described later in Examples.

The volume resistivity of the carrier particles can be controlled by controlling the volume resistivity of the core particles, the additive amount of coating resin (thickness of resin coating layer), the shape of the carrier particles, the amount of the conductive agent added to the resin coating layer, and the like. In addition, the volume resistivity of the core particles can be controlled by controlling the firing temperature when producing the core particles. The volume resistivity tends to increase as the firing temperature increases.

<Area Ratio of Core Particles Exposed on Carrier Particle Surface>

The area ratio of the core particles exposed on the carrier particle surface (hereinafter, also simply referred to as the exposed area ratio) is 10.0% or more and 18.0% or less. When the exposed area ratio is less than 10.0%, the resistance value of the carrier particles increases too high and the image defect at the initial stage and after continuous printing is likely to be caused. The image quality after continuous printing deteriorates when the exposed area ratio is greater than 18.0%. This is presumed to be due to the following mechanism; when the exposed area ratio is greater than 18.0%, the carrier particles are likely to adhere to the electrostatic latent image support and thus the electrostatic latent image support is likely to be easily damaged. The surface potential of the electrostatic latent image support is lowered due to such damage. The toner is developed on the portion where the surface potential is lowered and fogging is likely to be caused after continuous printing, and thus GI value decreases.

In addition, when the volume resistivity of the carrier particles is adjusted by the volume resistivity of the core particles (carrier core), the volume resistivity of the carrier particles decreases when the carrier coating layer is worn by continuous printing and the carrier particles are likely to adhere to the electrostatic latent image support. It is believed that it is possible to achieve the desired carrier volume resistivity and to suppress the deterioration in image quality in continuous printing by setting the exposed area ratio of the carrier core to 10.0% or more and 18.0% or less without lowering the volume resistivity of the carrier core. The exposed area ratio is preferably 10.5% or more and 18.0% or less and more preferably 12.0% or more and 18.0% or less.

The exposed portion of the core particles on the carrier particle surface can be determined by measuring the coating ratio of the coating layer with respect to the core particles by the following method through the XPS measurement (X-ray photoelectron spectroscopy). As the apparatus for XPS measurement, the K-Alpha manufactured by Thermo Fisher Scientific, K.K. is used, and the measurement is conducted with an Al monochromatic X-ray as the X-ray source by setting the acceleration voltage to 7 kV and the emission current to 6 mV. In addition, the measurement is conducted for the main element (usually carbon) constituting the coating layer and the main element (usually iron) constituting the core particles.

Hereinafter, it is described on the premise that the core particles are iron oxide type. Here, the C1s spectrum is measured for carbon, the Fe2p3/2 spectrum is measured for iron, and the O1s spectrum is measured for oxygen. The numbers of the elements of carbon, oxygen, and iron (represented by “AC”, “AO”, and “AFe”, respectively) are determined on the basis of the spectrum for each of these elements, the iron content rate in the simple substance of core particles and the core particles after being coated with the coating layer (carrier) are determined from the ratio of the numbers of the elements of carbon, oxygen, and iron thus obtained by the following Equation, and subsequently, the coating ratio is determined by the following Equation.

Iron content rate (atomic %)=AFe/(AC+AO+AFe)×100 [Math. 1]

Coating ratio (%)={1−(Iron content rate in carrier particles)/(Iron content rate in simple substance of core particles)}×100 [Math. 2]

It is “exposed area ratio of core particles (%)=100−coating ratio (%)”.

Incidentally, in the case of using a material other than iron oxide type as the core particles, the spectrum of the metal element constituting the core particles in addition to oxygen is measured and the same calculation is conducted in accordance with Equations described above to determine the coating ratio.

The area ratio of the core particles exposed on the carrier surface is not particularly limited, but for example, it can be controlled by controlling the mixing time after the addition of resin while heating and the amount of the coating resin added to the core particles. The exposed area ratio tends to increase as the mixing time after the addition of resin while heating increases and the exposed area ratio tends to decrease as the additive amount of the coating resin increases.

<Specific Gravity of Carrier Particles>

The carrier particles of the present embodiment are formed by coating the core particle surface with a coating resin. On the other hand, for example, the carrier described in JP 2005-181486 A is a dispersed in resin type carrier in which magnetic fine particles (fine particles having a peak value of from 10 to 60 nm on the basis of the number) are dispersed in a resin, the specific gravity thereof is relatively low (for example, apparent specific gravity of 1.5 g/cm³ or more and 2.0 g/cm³ or less in JP 2005-181486 A). On the other hand, in the carrier particles of the present embodiment, the carrier core is coated with a coating resin, and thus the specific gravity is higher as compared to the dispersed in resin type carrier. The apparent specific gravity of the carrier particles of the present embodiment is preferably 2.05 g/cm³ or more and more preferably from 2.05 to 2.50 g/cm³. The apparent specific gravity of the carrier particles can be measured in conformity with JIS-Z2504: 2012. In addition, the true specific gravity of the carrier particles in the present embodiment is preferably 3.0 g/cm³ or more and more preferably from 4.0 to 6.0 g/cm³. In addition, the true specific gravity can be measured using the true density measuring machine (VOLUMETER.VM-100 Model manufactured by Stec Co., Ltd.).

The carrier particles may contain an internal additive such as a resistance adjusting agent if necessary.

Hereinafter, the core particles and the coating resin which constitute the carrier particles will be described.

[Core Particles]

The average magnetization of core particles per one core particle in an applied magnetic field of 1 kilooersted (hereinafter, simply referred to as the average magnetization) is 3.5×10⁻¹⁰ AM²/particle or more and 5.0×10⁻⁹ AM²/particle or less. The image quality in continuous printing deteriorates when the average magnetization of the core particles exceeds 5.0×10⁻⁹ AM²/particle. This is presumed to be due to the following mechanism. When the average magnetization of the core particles exceeds 5.0×10⁻⁹ AM²/particle, the density of the magnetic brush formed on the developing roller (developing sleeve) by the developer increases, the contact frequency of the magnetic brush with the electrostatic latent image support increases, the electrostatic latent image support is easily damaged. The surface potential of the electrostatic latent image support is lowered due to such damage. The toner is developed on the portion where the surface potential is lowered and fogging is likely to be caused after continuous printing, and thus GI value decreases. On the other hand, the image quality in continuous printing deteriorates when the average magnetization of the core particles is less than 3.5×10⁻¹⁰ AM²/particle as well. This is presumed to be due to the following mechanism. When the average magnetization of the core particles is less than 3.5×10⁻¹⁰ AM²/particle, the carrier particles are likely to adhere to the electrostatic latent image support by centrifugal force and thus the electrostatic latent image support is easily damaged. The surface potential of the electrostatic latent image support is lowered due to such damage. The toner is developed on the portion where the surface potential is lowered and fogging is likely to be caused after continuous printing, and thus GI value decreases.

The average magnetization of the core particles is preferably 4.0×10⁻¹⁰ AM²/particle or more and 4.0×10⁻⁹ AM²/particle or less and more preferably 2.0×10⁻¹⁰ AM²/particle or more and 2.0×10⁻⁹ AM²/particle or less.

As the average magnetization of the core particles per one particle in an applied magnetic field of 1 kilooersted, the value measured by the method to be described below in Examples is adopted.

Incidentally, in the invention, the average magnetization per one particle is specified. The magnetization (AM²/kg) per weight is defined as the strength of magnetization of the carrier particles in some cases. In a case where the materials constituting the core particles are the same, the magnetization per weight is the same regardless of the particle size of the core particles. In other words, although the magnetization per weight (AM²/kg) is the same, the number of particles per weight increases when the particle size is small, and thus the average magnetization per particle becomes small. In the present embodiment, the particle size of the carrier particles is small, and thus the average magnetization per one particle is specified.

The average magnetization of the core particles can be controlled by appropriately changing the firing temperature when producing the core particles, the composition of the core particles, the particle size of the core particles, and the like. In the case of the ferrite particles containing MnO and MgO as the raw material, the average magnetization increases as the ratio (% by mole) of MnO in the ratio of MnO to MgO increases. In addition, in a case where the materials constituting the core particles are identical, the magnetization (AM²/kg) of the carrier is the same, and thus the average magnetization (AM²/particle) becomes small as the volume average particle size of the core particles becomes small.

The volume average particle size of the core particles is preferably 14 μm or more and 29 μm or less. It is excellent that the volume average particle size of the core particles is set to 14 μm or more from the viewpoint of being able to prevent the adhesion between the carrier particles and also to provide excellent image quality exhibiting decreased fogging and the like. It is possible to suppress an increase in exposed area of the core particles and it is easy to suppress the damage to the electrostatic latent image support as the volume average particle size of the core particles set to 29 μm or less. Incidentally, as the volume average particle size of the core particles, the median diameter (D₅₀) on a volume basis measured in the same manner as the method for measuring the volume average particle size of the carrier particles to be described below in Examples is adopted.

The carrier shape factor SF-1 of the core particles is not particularly limited, but it is preferably from 100 to 130 and more preferably from 105 to 125. As it is in such a range, the frictional force between the carrier particles and toner particles and the flowability of the carrier particles become suitable and rising of the charged amount of the toner particles becomes favorable. As SF-1 of the core particles, the value measured by the method to be described below in Examples is adopted. Incidentally, the shape factor SF-1 is an index indicating the sphericity, and the shape factor SF-1 is 100 in the case of a true sphere.

The volume resistivity of the core particles is preferably 1.0×10⁷ Ω·cm or more and 5.0×10⁹ Ω·cm or less and more preferably 1.0×10⁷ Ω·cm or more and 1.0×10⁹ Ω·cm or less since it is easy to control the volume resistivity of the carrier particles to a desired range. The volume resistivity of the core particles can be measured in the same manner as the method for measuring the volume resistivity of the carrier particles in Examples to be described later.

The saturation magnetization (magnetization per weight) of the core particles is preferably from 30 to 80 AM²/kg. As the core particles having such magnetic properties are used, it is prevented that the carrier particles are partly aggregated, the two-component developer is more uniformly dispersed on the surface of the developer conveying member, and it is possible to form a uniform and fine-grained toner image without density unevenness. The magnetization of the core particles can be measured by the method to be described below in Examples.

Incidentally, as the physical properties (average magnetization, saturation magnetization, volume average particle size, shape factor SF-1, volume resistivity, and the like) of the core particles, the physical properties of the core particles at the producing stage may be measured, or the resin coating layer is removed from the carrier particles and then the physical properties of the core particles may be measured. At this time, the method for removing the resin coating layer from the carrier particles is not particularly limited, but examples thereof may include the following methods; 2 g of the carrier is put in a 20 ml glass bottle, 15 ml of methyl ethyl ketone is then put in the glass bottle, and the mixture is stirred for 10 minutes using a wave rotor to dissolve the resin coating layer in the solvent. The solvent was removed using a magnet, the core particles are further washed with 10 ml of methyl ethyl ketone three times. The core particles washed are dried, thereby obtaining the core particles.

ses when the carrier coating layer is worn by magnetic metal metal such as iron, copper, nickel, or cobalt, a magnetic metal oxide such as ferrite. Among them, it is preferable that the core particles are preferably ferrite from the viewpoint of durability.

Ferrite is a compound represented by Formula: (MO)ₓ(Fe₂O₃)_{y}, and it is preferable to set the molar ratio y of Fe₂O₃ constituting ferrite to from 30 to 95 mol %. Ferrite which has a molar ratio y in such a range is easily magnetized to a desired extent, and thus it has an advantage of being able to be produced into carrier particles which hardly adhere to one another. As M in Formula, for example, a metal such as manganese (Mn), magnesium (Mg), strontium (Sr), calcium (Ca), titanium (Ti), copper (Cu), zinc (Zn), nickel (Ni), aluminum (Al), silicon (Si), zirconium (Zr), bismuth (Bi), cobalt (Co), or lithium (Li) may be employed. These metal atoms may be used singly or in combination of two or more kinds thereof. Among them, from the viewpoint of low residual magnetization and of obtaining suitable magnetic properties, manganese, magnesium, strontium, lithium, copper, and zinc are preferable, and manganese and magnesium are more preferable. In other words, the core particles according to the present embodiment are preferably ferrite particles containing at least one of manganese and magnesium. More preferably, the core particles according to the present embodiment are ferrite particles containing both manganese and magnesium. In this case, the content ratio of MnO is preferably set to from 20 to 40 mol % with respect to ferrite and the content ratio of MgO is preferably set to from 7 to 30 mol % since it is easy to control the average magnetization of the carrier core to a desired range.

As the core particles, a commercially available product may be used or a synthesized product may be used. In the case of synthesizing the core particles, for example, a method as described below is employed.

Ferrite can be produced by a known method. Examples thereof may include a method having the steps to be described below.

(1) Step of Mixing and Calcining Ferrite Raw Material

Ferrite raw materials such as Fe₂O₃, Mn(OH)₂, and Mg(OH)₂ are pulverized, and mixed for example, using a wet media mill, a ball mill, or a vibration mill to obtain a pulverized product. The pulverizing and mixing time at this time is preferably 0.5 hour or longer and more preferably from 1 to 30 hours. The ferrite raw materials are calcined after being pulverized.

The pulverized material may be pelletized before being calcined using a pressure molding machine or the like. In addition, the ferrite raw materials may be slurried by adding waster and then granulated using a spray dryer or the like before or after being pulverized without using a pressure molding machine.

As the firing device used in the calcination, it is possible to use a known firing device such as an electric furnace or a rotary kiln. The calcination is preferably conducted one time or more and three times or less if necessary. The calcination temperature is preferably from 700 to 1200° C., more preferably from 800 to 1100° C., and even more preferably from 900 to 1050° C. in order to obtain an oxide of the raw material.

Thereafter, the calcined particles are preferably pulverized in order to control the volume average particle size to a desired size. The pulverization condition at this time may be either of dry pulverization or wet pulverization, but it is preferable to include wet pulverization using a wet ball mill, zirconia beads, and the like since it is possible to make particles small. The wet pulverization time at this time is preferably from 20 to 40 hours and preferably from 25 to 35 hours.

(2) Step of Firing Calcined Particles

The calcined particles after being pulverized are subjected to firing. Upon the firing, water and if necessary a dispersing agent, a binder such as polyvinyl alcohol (PVA), and the like are added to the calcined particles to obtained a slurry, and this slurry may be granulated and dried using a spray dryer or the like.

The firing is preferably conducted while controlling the oxygen concentration. As the firing device used in the firing, it is possible to use a known firing device such as an electric furnace or a rotary kiln.

The distance between the crystal grains tends to become short and the volume resistivity of the core particles decreases as the temperature for firing increases. Hence, it is possible to control the volume resistivity of the carrier particles by controlling the temperature for firing. The temperature for firing is preferably from 900 to 1300° C. since it is easy to control the volume resistivity to a specific range. In addition, the time for firing is preferably from 5 to 30 hours. The SF-1 tends to increase as the time for firing increases since the carrier particles have irregular shapes.

The fired product obtained in this manner is pulverized and classified. The particle size of the fired product is adjusted to a desired value using an existing air classification, a mesh filtration method, a precipitation method, or the like as the classification method.

Thereafter, it is possible to adjust the electrical resistance of the fired product by heating the surface of the fired product at a low temperature to conduct oxide film treatment if necessary. As the oxide film treatment, it is possible to conduct a heat treatment, for example, at from 300 to 700° C. using a general rotary electric furnace, a batch-type electric furnace, or the like. The thickness of the oxide layer formed by this treatment is preferably from 0.1 nm to 5 μm. It is preferable that the thickness of the oxide layer is set to the above range since the effect of the oxide film layer is obtained and desired properties are easily obtained as the resistance does not increase too high. If necessary, the fired product may be subjected to reduction before the oxide film treatment. In addition, a low magnetic product may be further fractionated by the magnetic separation after the classification.

[Coating Resin]

It is preferable to contain a constitutional unit derived from an alicyclic (meth)acrylic acid ester as the constitutional unit contained in the coating resin. By containing a constitutional unit derived from an alicyclic (meth)acrylic acid ester compound, the hydrophobicity of resin increases, the water adsorption amount of the carrier particles decreases, the environmental difference in charging property decreases, and in particular a decrease in charged amount in a high temperature and high humidity environment is suppressed. In addition, a resin containing a constitutional unit derived from an alicyclic (meth)acrylic acid ester compound has a proper mechanical strength and is properly worn as a coating material, and thus there is also an advantage that the carrier particle surface is refreshed. Incidentally, in the present specification, the term “(meth)acrylic” means acrylic or methacrylic.

Examples of the alicyclic (meth)acrylic acid ester may include cyclopropyl (meth)acrylate, cyclobutyl (meth)acrylate, cyclopentyl (meth)acrylate, cyclohexyl (meth)acrylate, cycloheptyl (meth)acrylate, dicyclopentanyl (meth)acrylate, cyclododecyl (meth)acrylate, methylcyclohexyl (meth)acrylate, trimethylcyclohexyl (meth)acrylate, t-butylcyclohexyl (meth)acrylate, and adamantyl (meth)acrylate. Among them, a (meth)acrylic acid ester having a cycloalkyl ring having from 3 to 8 carbon atoms is preferable and cyclohexyl (meth)acrylate and cyclopentyl (meth)acrylate are more preferable as the alicyclic (meth)acrylic acid ester since the above effect is more easily obtained, and cyclohexyl methacrylate is even more preferable from the viewpoint of the mechanical strength and the environmental stability of the charged amount. The alicyclic (meth)acrylic acid esters may be used singly or in combination of two or more kinds thereof.

As the polymerization component, another monomer that is copolymerizable with the alicyclic (meth)acrylic acid ester may be used in addition to the alicyclic (meth)acrylic acid ester. Examples of another monomer may include a styrene compound such as styrene, o-methylstyrene, m-methylstyrene, p-methylstyrene, α-methylstyrene, p-chlorostyrene, 3,4-dichlorostyrene, p-phenylstyrene, p-ethylstyrene, 2,4-dimethylstyrene, p-tert-butylstyrene, p-n-hexylstyrene, p-n-octylstyrene, p-n-nonylstyrene, p-n-decylstyrene, or p-n-dodecylstyrene; a methacrylic acid ester compound such as methyl methacrylate, ethyl methacrylate, n-butyl methacrylate, isopropyl methacrylate, isobutyl methacrylate, t-butyl methacrylate, n-octyl methacrylate, 2-ethylhexyl methacrylate, stearyl methacrylate, lauryl methacrylate, phenyl methacrylate, benzyl methacrylate, isobornyl methacrylate, diethylaminoethyl methacrylate, or dimethylaminoethyl methacrylate; an acrylic acid ester compound such as methyl acrylate, ethyl acrylate, isopropyl acrylate, n-butyl acrylate, t-butyl acrylate, isobutyl acrylate, n-octyl acrylate, 2-ethylhexyl acrylate, stearyl acrylate, lauryl acrylate, phenyl acrylate, or benzyl acrylate; an olefin compound such as ethylene, propylene, or isobutylene; a vinyl halide compound such as vinyl chloride, vinylidene chloride, vinyl bromide, vinyl fluoride, or vinylidene fluoride; a vinyl ester compound such as vinyl propionate, vinyl acetate, or vinyl benzoate; a vinyl ether compound such as vinyl methyl ether or vinyl ethyl ether; a vinyl ketone compound such as vinyl methyl ketone, vinyl ethyl ketone, or vinyl hexyl ketone; a N-vinyl compound such as N-vinyl carbazole, N-vinyl indole, or N-vinyl pyrrolidone; a vinyl compound such as vinyl naphthalene or vinyl pyridine; an acrylic acid or methacrylic acid derivative such as acrylonitrile, methacrylonitrile, or acrylamide. These other monomers may be used singly or in combination of two or more kinds thereof. Among them, from the viewpoint of the mechanical strength and the environmental stability of charged amount, it is preferable to use a chain (meth)acrylic acid ester such as methyl (meth)acrylate, ethyl (meth)acrylate, propyl (meth)acrylate, n-butyl (meth)acrylate, hexyl (meth)acrylate, octyl (meth)acrylate, or 2-ethylhexyl (meth)acrylate or styrene, and it is more preferable to use a chain (meth)acrylic acid ester. It is preferable that the alkyl group of the chain (meth)acrylic acid ester has from 1 to 8 carbon atoms. A copolymer of an alicyclic (meth)acrylic acid ester with a chain (meth)acrylic acid ester is preferable since the carrier surface is easily refreshed and the copolymer exhibits excellent stress tolerance in the developing machine.

At this time, the content mass ratio of the alicyclic (meth)acrylic acid ester to the chain (meth)acrylic acid ester is not particularly limited. It is preferably alicyclic (meth)acrylic acid ester:chain (meth)acrylic acid ester=10:90 to 90:10 (mass ratio) and more preferably 30:70 to 70:30 (mass ratio) since the effect of suppressing the image defect with time is more easily obtained.

The method for producing the coating resin is not particularly limited, it is possible to appropriately utilize a known polymerization method, and examples thereof may include a pulverization method, an emulsion dispersion method, a suspension polymerization method, a solution polymerization method, a dispersion polymerization method, an emulsion polymerization method, an emulsion polymerization aggregation method, and other known methods. In particular, it is preferable to synthesize the coating resin by an emulsion polymerization method from the viewpoint of controlling the particle size.

The polymerization initiator and the surfactant which are used in the emulsion polymerization method other than the monomer, and further the chain transfer agent used if necessary, or the polymerization condition such as the polymerization temperature are not particularly limited, and it is possible to use a polymerization initiator, a surfactant, a chain transfer agent, and the like which are known in the prior art and it is also possible to adjust the polymerization condition such as the polymerization temperature by appropriately utilizing the polymerization condition known in the prior art.

The weight average molecular weight of the coating resin (polymer obtained by polymerizing the above monomer) is not particularly limited, but it is in a range of preferably from 200,000 to 800,000 and more preferably from 300,000 to 700,000. It is excellent that the weight average molecular weight of the coating resin is 200,000 or more since the attrition of the resin coating layer formed on the surface of the core particles by the coating resin is not excessively accelerated and adhesion of the carrier particles is hardly caused. When the weight average molecular weight of the coating resin is 800,000 or less, a decrease in charged amount due to the transition of the external additive from the toner particles to the carrier particle surface is not caused and a favorable charged amount can be maintained for a long period of time.

The weight average molecular weight of the coating resin is measured by gel permeation chromatography (GPC), and more specifically it is measured by the following method.

Using an apparatus “HLC-8220GPC” (manufactured by TOSOH CORPORATION) and a column “three TSKguardcolumn SuperHZ-L+TSKgel SuperHZM-M connected in series” (manufactured by TOSOH CORPORATION), tetrahydrofuran (THF) as the carrier solvent is allowed to flow at a flow rate of 0.35 ml/min while maintaining the column temperature is maintained at 40° C. The sample for measurement is dissolved in tetrahydrofuran under a dissolving condition to treat for 5 minutes at room temperature using an ultrasonic dispersing machine so as to have a concentration of 1 mg/ml, and subsequently, the solution is treated with a membrane filter having a pore size of 0.2 μm to obtain a sample solution. Together with the carrier solvent, 10 μL of this sample solution is injected into the apparatus, and detected using a refractive index detector (RI detector), and the weight average molecular weight distribution of the sample for measurement is calculated using the calibration curve that is measured using monodispersed polystyrene standard particles. Polystyrene used for calibration curve measurement is 10.

Incidentally, a conductive agent such as carbon black may be contained in the resin coating layer formed from the coating resin for the purpose of adjusting the volume resistivity of the carrier particles.

The glass transition point (Tg) of the coating resin is preferably from 60 to 180° C. and more preferably from 80 to 150° C.

The film thickness of the resin coating layer formed from the coating resin is preferably from 0.05 to 4 μm and more preferably from 0.2 to 3 μm. It is possible to improve the charging property and durability of the carrier particles when the film thickness of the resin coating layer is within the above range.

Incidentally, the film thickness of the resin coating layer can be determined by the following method.

The sample for measurement is prepared by cutting the carrier particles in a plane passing through the center of the carrier particle using a focused ion beam system “SMI2050” (manufactured by Hitachi High-Tech Science Corporation). The cross section of the sample for measurement is observed using a transmission electron microscope “JEM-2010F” (manufactured by JEOL Ltd.) in the field of vision magnified by 5000 times, and the average value of the portion having the maximum film thickness and the portion having the minimum film thickness in that field of vision is adopted as the film thickness of the resin coating layer. Incidentally, the number of measurement is set to 50, and the number of the field of vision is increased until the number of measurement becomes 50 in a case where the photograph by one field of vision is insufficient.

[Method for Producing Carrier Particles]

Examples of the method for coating the surface of the core particles with the coating resin may include a wet coating method and a dry coating method, and the resin coating layer can be formed by either method. The respective methods will be described below.

(Wet Coating Method)

Examples of the wet coating method may include:

(1) Fluidized Bed Spray Coating Method

A method for producing the carrier particles having the surface of the core particles coated with the coating resin in which a coating liquid prepared by dissolving the coating resin in a solvent is spray coated on the surface of the core particles using a fluidized spray coating device and then dried;

(2) Immersion Coating Method

A method for producing the carrier particles having the surface of the core particles coated with the coating resin in which the core particles are immersed in a coating liquid prepared by dissolving the coating resin in a solvent as the coating treatment and then dried; and

(3) Polymerization Method

A method for producing the carrier particles having the surface of the core particles coated with the coating resin in which the core particles are immersed in a coating liquid prepared by dissolving a reactive compound for forming the coating resin (containing a polymerization initiator and the like in addition to the monomer for synthesizing the coating resin) in a solvent as the coating treatment and then subjected to the polymerization reaction by applying heat and the like to form a resin coating layer.

(Dry Coating Method)

The dry coating method is a method (hereinafter, also referred to as the mechanochemical method) to coat the coating resin on the surface of the core particles by applying a mechanical impact or heat and is a method to form a resin coating layer by the following steps 1, 2 and 3.

First step: the materials prepared by blending the core particles, the coating resin, and an additive to be added if necessary in appropriate amounts are mixed (mechanical stirring) at room temperature (20 to 30° C.) to attach the coating resin and the additive added if necessary on the surface of each of the core particles as a uniform layer.

Second step: thereafter, the coating resin particles in the coating material attached on the core particle surface is melted or softened by applying a mechanical impact or heat to fix, thereby forming a resin coating layer.

Third step: subsequently, the resultant is cooled to room temperature (20 to 30° C.).

In addition, it is also possible to form the resin coating layer having a desired thickness by repeating the first to third steps several times if necessary.

It is preferable that the second step is a step in which the coating resin is spread, fixed, and coated on the surface of the core particles by applying a mechanical impact force while heating the core particles having the coating resin attached thereon at a temperature equal to or higher than the glass transition temperature of the coating resin, to form the resin coating layer.

Examples of the apparatus for applying a mechanical impact or heat in the second step may include a turbo mill, a pin mill, a grinding mill having a rotor and a liner, such as Kryptron, and a high-speed stirring mixer with a horizontal stirring blade. Among these, a high-speed stirring mixer with a horizontal stirring blade is preferable since a resin coating layer can be favorably formed.

In the case of heating the coating resin in the second step, the heating temperature is preferably in a temperature range higher than the glass transition temperature of the coating resin by from 5 to 20° C., and specifically, it is preferably in a range of by from 60 to 130° C. When the coating resin is heated at a temperature within such a range, the aggregation among the carrier particles does not occur, the coating resin is fixed on the surface of the core particles, and thus a resin coating layer having a uniform layer can be formed.

In the dry coating method described above, an organic solvent and the like are not used as well, and thus not only the missing holes of the solvent are not formed on the resin coating layer and the resin coating layer is dense and robust but also the carrier particles can be produced by forming a resin coating layer exhibiting favorable adhesive property to the core particles is formed.

As the method for forming the carrier particles in which the surface of the core particles is coated with a coating resin in the present embodiment, it is even more preferable to utilize the dry coating method described above from the viewpoint of not using a solvent, a small environmental burden, and being able to uniformly coat the core particle surface with the coating resin.

The core material exposed area on the carrier particles can be controlled by the stirring time at the time of heating in the dry coating method. The resin particles are attached to the core particles and the resin spreads and forms a film as mixing and stirring are conducted while heating, the spreading proceeds and the resin forms a this film as the time increases and thus the exposed area tends to increase. In order to set the exposed area of the core particles on the carrier particle surface to 10% or more and 18% or less, the stirring time at the time of heating is set to preferably from 30 to 70 minutes and more preferably from 40 to 60 minutes.

The mixing ratio of the coating resin to the carrier core material is appropriately set in consideration of the film thickness of the resin coating film of the carrier to be obtained, and it is not particularly limited, but it is preferably from 1 to 10 parts by mass and more preferably from 2 to 6 parts by mass with respect to 100 parts by mass of the core particles.

[Toner Particles]

As the toner particles, those obtained by attaching an external additive to toner maternal particles (toner base material particles) are preferable. Incidentally, the toner obtained by attaching the external additive to the toner maternal particles is preferable since the flowability of the two-component developer is improved.

<The Volume Average Particle Size of Toner Particles>

The volume average particle size of the toner particles is 3.0 μm or more and 5.0 μm or less. The flowability of the toner particles and rising of the charged amount of the toner particles decrease when the volume average particle size is less than 3.0 μm. Hence, the image quality at the initial stage and after continuous printing deteriorates. On the other hand, when it exceeds 5.0 μm, the toner dots forming an image are ununiform and thus the image quality at the initial stage and after continuous printing deteriorates. The volume average particle size of the toner particles is preferably 3.5 μm or more and 4.5 μm or less.

As the volume average particle size of the toner particles, the median diameter (D₅₀) on a volume basis measured by the method to be described in Examples is adopted.

The volume average particle size of the toner particles can be controlled by controlling the concentration of the aggregating agent or the additive amount the organic solvent or the fusion time and the like in the producing method to be described later.

<Average Circularity of Toner Particles>

The average circularity of the toner particles is preferably 0.970 or more. The image quality at the initial stage and after continuous printing is improved by setting the average circularity of the toner particles to 0.970 or more. It is believed that this is because the contact area between the toner particles and the carrier particles decreases and thus the non-electrostatic adhesion force can be lowered. In addition, it is believed that this is because the flowability of the toner particles increases and charging rising becomes advantageous as the average circularity of the toner particles is set to 0.970 or more. The average circularity of the toner particles is more preferably 0.970 or more and 0.990 or less.

Incidentally, the average circularity can be measured, for example, using a flow type particle image analyzer “FPIA-3000” (manufactured by Sysmex Corporation), and specifically, it can be measured by the method to be described in the following Examples.

The average circularity of the toner particles can be controlled by controlling the temperature, time, and the like at the time of the aging treatment in the producing method to be described later.

<Toner Maternal Particles>

It is preferable that the toner maternal particles specifically contains at least a binder resin (hereinafter, also referred to as the “resin for toner”), and it can also contain other components (internal additives) such as a colorant, a releasing agent, and a charge control agent if necessary.

(Binder Resin)

As the binder resin constituting the toner maternal particles, it is preferable to use a thermoplastic resin.

As such a binder resin, those which are generally used as the binder resin constituting the toner can be used without particular limitation, and specific examples thereof may include a styrene resin, an acrylic resin, a styrene-acrylic copolymer resin, a polyester resin, a silicone resin, an olefin-based resin, an amide resin, and an epoxy resin.

Among them, a styrene resin, an acrylic resin, a styrene-acrylic copolymer resin, and a polyester resin which exhibit melting properties having a low viscosity and high sharp melt property are suitably mentioned. These may be used singly or in combination of two or more kinds thereof. It is preferable that the toner particles contain at least a crystalline polyester resin particularly from the viewpoint of easily dissolving the toner particles and achieving energy saving at the time of fixing. Incidentally, in the present specification, the term “crystalline” means that one does not have a stepwise endothermic change but has a clear endothermic peak in the differential scanning calorimetry. At this time, the clear endothermic peak specifically means a peak in which the half width of the endothermic peak is within 15° C. when measured at a temperature raising rate of 10° C./min in the differential scanning calorimetry (DSC) to be described below.

Differential Scanning Calorimetry (DSC)

The endothermic peak temperature of the crystalline polyester resin is obtained in conformity with ASTM D3418 using a differential scanning calorimeter (manufactured by Shimadzu Corporation: DSC-60A). The melting point of indium and zinc is used for the temperature correction of the detecting unit of this apparatus (DSC-60A), and the heat of fusion of indium is used for the correction of heat quantity. An aluminum pan is used as the sample and an empty pan is set as the control, and the temperature thereof is raised at a temperature raising rate of 10° C./min, held for 5 minutes at 200° C., lowered from 200° C. to 0° C. at 10° C./min using liquid nitrogen, held for 5 minutes at 0° C., and raised again from 0° C. to 200° C. at 10° C./min. The endothermic curve obtained during the second heating is analyzed, and the maximum peak is adopted as the endothermic peak temperature for the crystalline polyester resin.

The crystalline polyester resin is synthesized from a polycarboxylic acid component and a polyhydric alcohol component.

Examples of the polycarboxylic acid component may include an aliphatic dicarboxylic acid such as oxalic acid, succinic acid, glutaric acid, adipic acid, suberic acid, azelaic acid, sebacic acid, 1,9-nonanedicarboxylic acid, 1,10-decanedicarboxylic acid, dodecanedioic acid (1,12-dodecanedicarboxylic acid), 1,14-tetradecanedicarboxylic acid, or 1,18-octadecanedicarboxylic acid; and an aromatic dicarboxylic acid such as a dibasic acid including phthalic acid, isophthalic acid, terephthalic acid, naphthalene-2,6-dicarboxylic acid, malonic acid, or mesaconic acid. Furthermore, any lower alkyl ester or any acid anhydride thereof may also be mentioned, but it is not limited thereto. These may be used singly or two or more kinds thereof may be used concurrently.

In addition, examples of the trivalent or higher carboxylic acids may include 1,2,4-benzenetricarboxylic acid, 1,2,5-benzenetricarboxylic acid, and 1,2,4-naphthalenetricarboxylic acid, and any lower alkyl ester or any acid anhydride thereof. These may be used singly or two or more kinds thereof may be used concurrently. Furthermore, a dicarboxylic acid component having a double bond may be used in addition to the polycarboxylic acid component. Examples of the dicarboxylic acid having a double bond may include maleic acid, fumaric acid, 3-hexenedioic acid, and 3-octenedioic acid, but it is not limited thereto. In addition, any lower alkyl ester or any acid anhydride thereof may also be mentioned.

Meanwhile, as the polyhydric alcohol component, an aliphatic diol is preferable and a straight chain type aliphatic diol having from 7 to 20 carbon atoms at the main chain is more preferable. When the aliphatic diol is a straight chain type one, the crystallinity of the polyester resin is maintained and a drop in melting temperature is suppressed, and thus the toner blocking resistance, the image preservability, and the low temperature fixability are excellent. In addition, when the number of carbon atoms is from 7 to 20, the melting point when being polycondensed with the polycarboxylic acid component is kept low, low temperature fixing is achieved, and the material is easily available in practice. It is more preferable that the number of carbon atoms at the main chain moiety is 7 or more and 14 or less.

Specific examples of the aliphatic diol that is suitably used in the synthesis of the crystalline polyester resin may include ethylene glycol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecane diol, 1,13-tridecanediol, 1,14-tetradecanediol, and 1,18-octadecanediol, but it is not limited thereto. These may be used singly or two or more kinds thereof may be used concurrently. Among these, 1,8-octanediol, 1,9-nonanediol, and 1,10-decanediol are preferable in consideration of easy availability. Examples of the trihydric or higher alcohol may include glycerin, trimethylolethane, trimethylolpropane, and pentaerythritol. These may be used singly or two or more kinds thereof may be used concurrently.

The crystalline polyester resin may be synthesized by conducting the polycondensation reaction of the polycarboxylic acid component with the polyhydric alcohol component in the presence of a polymerization catalyst such as dibutyltin oxide or tetrabutoxy titanate in accordance with a conventional method.

It is preferable that the polycondensation reaction is conducted at a reaction temperature of 180° C. or higher and 230° C. or lower. The reaction is conducted while lowering the internal pressure of the reaction system if necessary and removing water or an alcohol generated by the polycondensation. In a case where the monomer is not dissolved or compatibilized at the reaction temperature, the monomer may be dissolved by adding a solvent having a high boiling point as a solubilizing agent. The polycondensation reaction is conducted while distilling off the solubilizing solvent. In a case where there is a monomer that is poor in compatibility in the copolymerization reaction, the poorly compatible monomer and the acid or alcohol that is intended to be polycondensed with the monomer may be condensed in advance and the condensed product may be then polycondensed with the main component.

The weight average molecular weight of the crystalline polyester resin is preferably from 5,000 to 50,000 from the viewpoint of favorable low temperature fixability and image preservability. Incidentally, in the present specification, the weight average molecular weight of the crystalline polyester resin is a value measured by GPC, and it can be measured under the same measurement condition as that in the coating resin.

As a polymerizable monomer for obtaining a binder resin other than the crystalline polyester resin (hereinafter, also referred to as the “other resin”), it is possible to use a styrene monomer such as styrene, methyl styrene, methoxy styrene, butyl styrene, phenyl styrene, or chlorostyrene; an acrylic acid ester monomer such as methyl acrylate, ethyl acrylate, n-butyl acrylate, 2-ethylhexyl acrylate, or n-stearyl acrylate; a methacrylic acid ester monomer such as methyl methacrylate, ethyl methacrylate, n-butyl methacrylate, or 2-ethylhexyl methacrylate; and carboxylic acid monomer such as acrylic acid, methacrylic acid, or fumaric acid. These polymerizable monomers may be used singly or in combination of two or more kinds thereof.

These other resins can be produced by a known method such as a suspension polymerization method, an emulsion polymerization method, or a dispersion polymerization method. Among them, an emulsion polymerization method is preferable from the viewpoint of controlling the particle size.

In the case of producing the other resin by an emulsion polymerization method, as the radical polymerization initiator to be used, it is possible to use, for example, a persulfate salt such as potassium persulfate or ammonium persulfate, a water-soluble azo compound such as 4,4′-azobis(4-cyanovaleric acid) or 2,2′-azobis(2-amidinopropane) hydrochloride, and hydrogen peroxide. These radical polymerization initiators can also be used as a redox polymerization initiator as desired. Examples thereof may include a combination of a persulfate salt and sodium metabisulfite and sodium sulfite and a combination of hydrogen peroxide and ascorbic acid. In addition, examples of the chain transfer agent to be used may include a thiol compound such as n-dodecyl mercaptan, tert-dodecylmercaptan, or n-octyl mercaptan, and halogenated methane such as tetrabromomethane or tribromochloromethane.

In a case where the polymerization is conducted in an aqueous medium using the polymerizable monomer, it is preferable to uniformly disperse the oil droplets of the polymerizable monomer in the aqueous medium using a surfactant. At this time, the surfactant which can be used is not particularly limited, but for example, the following ionic surfactant can be used as a preferred one. Examples of the ionic surfactant may include a sulfonate salt, a sulfate salt, and a fatty acid salt. Examples of the sulfonate salt may include sodium dodecylbenzenesulfonate, sodium aryl alkyl polyether sulfonate, sodium 3,3-disulfonate diphenyl urea-4,4-diazo-bis-amino-8-naphthol-6-sulfonate, o-carboxybenzene-azo-dimethyl aniline, and sodium 2,2,5,5-tetramethyl-triphenylmethane-4,4-diazo-bis-β-nap hthol-6-sulfonate. Examples of the sulfuric acid ester salt may include sodium dodecyl sulfate, sodium lauryl sulfate, sodium tetradecyl sulfate, sodium pentadecyl sulfate, and sodium octyl sulfate, and examples of the fatty acid salt may include sodium oleate, sodium laurate, sodium caprate, sodium caprylate, sodium caproate, potassium stearate, calcium oleate, and sodium polyoxyethylene-2-dodecyl ether sulfate.

As the surfactant, it is also possible to use a nonionic surfactant, and specific examples thereof may include polyethylene oxide, polypropylene oxide, a combination of polypropylene oxide with polyethylene oxide, an ester of polyethylene glycol with a higher fatty acid, alkylphenol polyethylene oxide, an ester of a higher fatty acid with polyethylene glycol, an ester of a higher fatty acid with polypropylene oxide, and a sorbitan ester.

The weight average molecular weight of the other resin is preferably from 10,000 to 50,000 from the viewpoint of low temperature fixability and image preservability. Incidentally, the weight average molecular weight of the other resin is a value measured by GPC, and it can be measured under the same measurement condition as that in the coating resin.

(Internal Additive)

Internal additives such as a colorant, a releasing agent, and a charge control agent may be contained in the toner maternal particles if necessary.

Examples of the colorant may include known inorganic or organic colorants. Specific colorants are exemplified below.

Examples of a black colorant may include carbon black such as furnace black, channel black, acetylene black, thermal black, and lamp black or magnetic powders such as magnetite and ferrite.

Examples of the colorant for magenta or red may include the C. I. Pigment Red 2, 3, 5, 6, 7, 15, 16, 48: 1, 53: 1, 57: 1, 60, 63, 64, 68, 81, 83, 87, 88, 89, 90, 112, 114, 122, 123, 139, 144, 149, 150, 163, 166, 170, 177, 178, 184, 202, 206, 207, 209, 222, 238, and 269.

In addition, examples of the colorant for orange or yellow may include the C. I. Pigment Orange 31 and 43 and the C. I. Pigment Yellow 12, 14, 15, 17, 74, 83, 93, 94, 138, 155, 162, 180, and 185.

Furthermore, examples of the colorant for green or cyan may include the C. I. Pigment Blue 2, 3, 15, 15:2, 15:3, 15:4, 16, 17, 60, 62, and 66 and the C. I. Pigment Green 7.

In addition, examples of the dye may include the C. I. Solvent Red 1, 49, 52, 58, 63, 111, and 122, the C. I. Solvent Yellow 2, 6, 14, 15, 16, 19, 21, 33, 44, 56, 61, 77, 79, 80, 81, 82, 93, 98, 103, 104, 112, and 162, the C. I. Solvent Blue 25, 36, 60, 70, 93, and 95.

These colorants may be used singly or two or more kinds thereof may be used concurrently if necessary. In the case of using the colorant, the added amount thereof is preferably from 1 to 30% by mass and more preferably from 2 to 20% by mass with respect to the toner maternal particles.

As the colorant, it is also possible to use a surface-modified one. As the surface modifier, it is also possible to use those known in the prior art, and specifically a silane coupling agent, a titanium coupling agent, and an aluminum coupling agent can be preferably used.

A releasing agent may be contained in the toner maternal particles. The releasing agent is not particularly limited, and examples thereof may include a hydrocarbon-based wax such as polyethylene wax, oxidized polyethylene wax, polypropylene wax, oxidized polypropylene wax, and paraffin wax, carnauba wax, fatty ester wax, Sasol wax, rice wax, candelilla wax, jojoba oil wax, and beeswax.

The proportion of the releasing agent contained in the toner maternal particles is usually from 1 to 30 parts by mass and more preferably from 5 to 20 parts by mass with respect to 100 parts by mass of the binder resin for forming the toner maternal particles.

In addition, a charge control agent (also referred to as the charging control agent) may be contained in the toner maternal particles if necessary. As the charge control agent, it is possible to use various known compounds. Examples thereof may include a metal complex (metal complex of salicylic acid) of a salicylic acid derivative by zinc or aluminum, a calixarene-based compound, an organic boron compound, and a fluorine-containing quaternary ammonium salt compound. The proportion of the charge control agent contained in the toner maternal particles is usually from 0.1 to 5.0 parts by mass with respect to 100 parts by mass of the binder resin.

<External Additive>

As the external additive, it is possible to use metal oxide particles known in the prior art for the purpose of controlling the flowability or charging property, and examples thereof may include silica particles, titania particles, alumina particles, zirconia particles, zinc oxide particles, oxide chromium particles, cerium oxide particles, antimony oxide particles, tungsten oxide particles, tin oxide particles, tellurium oxide particles, manganese oxide particles, and boron oxide particles. These may be used singly or two or more kinds thereof may be used concurrently.

Particularly with regard to the silica particles, it is more preferable to use silica particles produced by a sol-gel method. The silica particles produced by a sol-gel method are preferable since they have a feature to have a narrow particle size distribution and thus the variation in adhesion strength is suppressed. The number average primary particle size of the silica particles formed by a sol-gel method is preferably in a range of from 70 to 150 nm. The silica particles having the number average primary particle size within such a range have a larger particle size compared with other external additives, and thus they play a role as a spacer, have an effect of preventing another external additive having a smaller particle size from being buried in the toner maternal particles by being stirred and mixed in the developing machine, and have an effect of preventing the toner maternal particles from being fused with one another.

The number average primary particle size of the metal oxide particles other than the silica particles produced by a sol-gel method is preferably from 10 to 70 nm and more preferably from 10 to 40 nm. Incidentally, the number average primary particle size of the metal oxide particles can be measured, for example, by a method in which the particle size is determined by the image processing of an image taken using a transmission electron microscope.

In addition, the organic fine particles composed of a homopolymer of styrene, methyl methacrylate, or the like or a copolymer thereof may be used as the external additive.

The metal oxide particles used as the external additive are preferably those which have the surface subjected to the hydrophobic treatment by a known surface treatment agent such as a coupling agent. As the surface treatment agent, dimethyldimethoxysilane, hexamethyldisilazane (HMDS), methyltrimethoxysilane, isobutyltrimethoxysilane, and decyltrimethoxysilane are preferable.

In addition, it is also possible to use silicone oil as the surface treatment agent. Specific examples of the silicone oil may include a cyclic compound such as organosiloxane oligomer, octamethylcyclotetrasiloxane, decamethylcyclopentasiloxane, tetramethylcyclotetrasiloxane, or tetravinyltetramethylcyclotetrasiloxane, or a straight chain or branched organosiloxane. In addition, silicone oil which is highly reactive as a modifying group is introduced into the side chain, one terminal, both terminals, one terminal of the side chain, both terminals of the side chain, or the like and at least has a modified terminal may be used. Examples of the modifying groups may include an alkoxy group, a carboxyl group, a carbinol group, higher fatty acid-modified, a phenol group, an epoxy group, a methacrylic group, and an amino group, but it is not particularly limited. In addition, for example, it may be silicone oil having several kinds of modifying group, such as amino/alkoxy-modified silicone oil.

In addition, the metal oxide particles may be subjected to a mixed treatment or combined treatment using dimethyl silicone oil, the modified silicone oil, and further other surface treatment agents. Examples of the treating agent to be concurrently used may include a silane coupling agent, a titanate-based coupling agent, an aluminate-based coupling agent, various kinds of silicone oil, a fatty acid, a metal salt of a fatty acid, any ester compound thereof, and rosin acid.

It is also possible to use a lubricant as an external additive in order to further improve the cleaning property or transferability, and examples of the lubricant may include metal salts of higher fatty acids such as zinc, aluminum, copper, magnesium, and calcium salts of stearic acid, zinc, manganese, iron, copper, and magnesium salts of oleic acid, zinc, copper, magnesium, and calcium salts of palmitic acid, zinc and calcium salts of linoleic acid, and zinc and calcium salts of ricinoleic acid.

The amount of these external additives added is preferably from 0.1 to 10% by mass and more preferably from 1 to 5% by mass with respect to the entire toner particles.

[Method for Producing Toner Particles]

<Method for Producing Toner Maternal Particles>

The toner maternal particles according to the present embodiment, namely, the particles at the stage before the external additive is added thereto can be produced by a known toner production method. The method for producing the toner maternal particles is not particularly limited, and examples thereof may include a pulverization method, a suspension polymerization method, a mini-emulsion polymerization aggregation method, an emulsion polymerization aggregation method, a dissolution suspension method, a polyester molecule elongation method, and other known methods. Among these, a pulverization method or an emulsion polymerization aggregation method is preferable from the viewpoint of the productivity and the toner physical properties such as low temperature fixability. Among these, an emulsion polymerization aggregation method can be said to be an advantageous method for producing a toner which has a small particle size and is for forming a high quality image such as a fine dot image or a fine line image since the method can form particles while controlling the size or shape.

The emulsion polymerization aggregation method is a method for producing toner particles in which the dispersion of the binder resin fine particles obtained by emulsion polymerization is mixed with if necessary the dispersion of the colorant fine particles and the dispersion of other toner particle constituting components such as the releasing agent fine particles, the fine particles are slowly aggregated while balancing between the repulsive force of the fine particle surface due to the pH adjustment and the cohesive force due to the addition of the aggregating agent composed of an electrolyte body, the association of the fine particles is conducted while controlling the average particle size and the particle size distribution, and at the same time the fusion among the fine particles is conducted by heating and stirring to control the shape. At this time, the binder resin fine particles may be formed into a multi-layered structure such as a core-shell structure by the multi-stage polymerization. The number of layers at this time is not particularly limited, but it is preferably 2 or 3 layers.

In the emulsion polymerization aggregation method, first, the resin particles of the binder resin of about 100 nm are formed by a polymerization method or a suspension polymerization method, and these resin particles are aggregated and fused to form toner particles. More specifically, the monomers constituting the binder resin are put in an aqueous medium and dispersed, and these polymerizable monomers are polymerized using the polymerization initiator, whereby the particles (dispersion) of the binder resin are produced. In addition, in the case of containing a colorant, separately, a colorant is dispersed in an aqueous medium to prepare a colorant fine particle dispersion. The median diameter (D₅₀) on a volume basis of the colorant fine particles in the dispersion is preferably from 80 to 200 nm. The median diameter on a volume basis of the colorant fine particles in the dispersion can be measured, for example, using the Microtrac particle size distribution analyzer UPA-150 manufactured by NIKKISO CO., LTD.

Subsequently, the resin particles described above and the colorant fine particles if necessary are aggregated in the aqueous medium and fused at the same time with the aggregation, thereby producing the toner maternal particles. In other words, an alkali metal salt, a group 2 element salt and the like as an aggregating agent is added into the aqueous medium obtained by mixing the resin particle dispersion and the colorant fine particle dispersion, the aggregation is conducted by heating at a temperature equal to or higher than the glass transition temperature of the resin particles and the resin particles are fused with one another at the same time. Thereafter, the aggregation is stopped by adding a salt when the size of the toner maternal particles reaches the target size. Thereafter, aging is conducted by subjecting the reaction system to the heat treatment until the shape of toner maternal particles becomes a desired shape, thereby completing the toner maternal particles.

At the time of aggregation, it is preferable to minimize the standing time (time until heating is started) to leave the dispersion to stand after the aggregating agent is added, to start heating of the dispersion as soon as possible, and to raise the temperature to the glass transition temperature of the binder resin or higher. The standing time is usually set to 30 minutes or shorter and preferably 10 minutes or shorter. The temperature for adding the aggregating agent is not particularly limited, but it is preferably equal to or lower than the glass transition temperature of the binder resin. Thereafter, it is preferable to rapidly raise the temperature by heating, and the temperature raising rate is preferably set to 0.5° C./min or more. The upper limit of the temperature raising rate is not particularly limited. It is preferably set to 15° C./min or less from the viewpoint of suppressing the generation of coarse particles by rapid progress of fusion. Furthermore, fusion is continued by maintaining the temperature of the dispersion for a predetermined time after the dispersion for aggregation has reached the glass transition temperature or higher. By virtue of this, it is possible to effectively conduct the growth of toner maternal particles (aggregation of the binder resin particles and the colorant particles) and the fusion (loss of the interface between the particles).

In more detail, it is preferable to adjust the pH to from 9 to 12 in advance by adding a base such as an aqueous solution of sodium hydroxide into the dispersion of the colorant particles and the binder resin particles in order to impart the aggregability. Subsequently, the aggregating agent such as an aqueous solution of magnesium chloride is preferably added to the dispersion containing the colorant particles and the binder resin particles at from 25 to 35° C. over from 5 to 15 minutes while stirring. The amount of the aggregating agent used is preferably suitably from 5 to 20% by mass with respect to the total solid content of the binder resin particles and the colorant particles. Thereafter, the resultant is left to stand for from 1 to 6 minutes, and the temperature thereof is preferably raised to from 70 to 95° C. over from 30 to 90 minutes. The aggregated resin particles and colorant particles can be fused by such a method. At this time, the growth of particles is stopped by adding an aqueous solution of sodium chloride or the like when the median diameter on a volume basis of the fused toner maternal particles measured is from 3.0 to 5.0 μm. Furthermore, it is also possible to conduct the fusion of the particles by heating and stirring the resultant liquid at the liquid temperature of from 80 to 100° C. as the aging treatment until the average circularity reaches 0.970 or more.

The aggregating agent in the aggregation step is not particularly limited, but those selected from the metal salts are preferably used. Examples thereof may include a salt of a monovalent metal such as a salt of an alkali metal such as sodium, potassium, or lithium, for example, a salt of a divalent metal such as calcium, magnesium, manganese, or copper, a salt of a trivalent metal such as iron or aluminum. Specific examples of the salt may include sodium chloride, potassium chloride, lithium chloride, calcium chloride, magnesium chloride, zinc chloride, copper sulfate, magnesium sulfate, and manganese sulfate, and a salt of a divalent metal is even more preferable among these. It is possible to conduct the aggregation with a smaller amount when a salt of a divalent metal is used. These aggregating agents may be used singly or in combination of two or more kinds thereof.

The dispersion in aggregation step may contain the releasing agent and the charge control agent which are described above, and further, known additives such as a dispersion stabilizer and a surfactant. These additives may be introduced to the aggregation step as a dispersion of the additive or may be contained in the dispersion of the colorant fine particles or the dispersion of the binder resin.

The particles thus obtained may be used as toner maternal particles as they are or may be used as the core particles so as to be formed into a core-shell particles by being fused with the shell particles composed of the binder resin.

It is preferable to filter the dispersion of the toner maternal particles obtained by the method described above and to dry. Examples of the filtration treatment method may include a centrifugal separation method, a reduced pressure filtration method to be carried out using the Nutsche or the like, and a filtration method to be carried out using a filter press or the like, and it is not particularly limited. Subsequently, the toner maternal particles (cake-like aggregate material) thus filtered are washed with ion-exchanged water to remove attached substances such as the surfactant and the aggregating agent. With regard to the washing treatment, it is preferable to conduct the washing treatment until the electric conductivity of the filtrate reaches a level of from 3 to 10 μS/cm, for example.

Drying is not particularly limited as long as the toner maternal particles washed is dried, and examples of the dryer may include a known dryer such as a spray dryer, a vacuum freeze dryer, or a vacuum dryer, and it is possible to use a shelf-type static dryer, a shelf-type mobile dryer, a fluidized bed dryer, a rotary dryer, a stirring-type dryer, an airflow type dryer, and the like. The water content in the dried toner maternal particles is preferably 5% by mass or less and more preferably 2% by mass or less (lower limit: 0% by mass).

In addition, the crushing treatment may be conducted in a case where the toner maternal particles subjected to the drying treatment are aggregated with one another by a weak inter-particle attractive force. Here, it is possible to use a mechanical crushing device such as a jet mill, the Henschel mixer, a coffee mill, or a food processor as the crushing device.

<Method for Adding External Additive>

The method for adding the external additive to the toner maternal particles is not particularly limited, but examples thereof may include a dry method in which the external additive as a powder is added to the toner maternal particles obtained after drying and mixed. As the device for mixing the external additive, it is possible to use various known mixing devices such as the Turbula mixer, the Henschel mixer, the Nauta mixer, and a V-type mixer. For example, in the case of using the Henschel mixer, the peripheral speed of the tip of the stirring blade is preferably set to from 30 to 80 m/s, and the external additive is stirred and mixed for about from 10 to 30 minutes at from 20 to 50° C.

[Two-Component Developer]

The two-component developer contains the carrier particles and the toner particles. Preferably, the two-component developer is composed of the carrier particles and the toner particles.

The ratio of the toner particles to the sum of the carrier particles and the toner particles is preferably from 8.0 to 10.0% by mass. As the ratio of the toner particles is from 8.0 to 10.0% by mass, the charged amount of the toner is proper and the image quality at the initial stage and after continuous printing is more favorable.

The two-component developer can be produced by mixing the carrier particles and the toner particles using a mixing device. Examples of the mixing device may include the Henschel mixer, the Nauta mixer, and a V-type mixer.

[Image Forming Method]

The two-component developer of the present embodiment can be used in various known image forming methods of an electrophotographic system, and for example, it can be used in the monochrome image forming method and the full-color image forming method. In the full-color image forming method, it is possible to use any image forming method such as an image forming method of a four-cycle type composed of four kinds of color developing units according to each of yellow, magenta, cyan, and black and one electrostatic latent image support or an image forming method of a tandem type equipped with an image forming unit having a color developing unit and an electrostatic latent image support according to the respective colors for each color.

As the electrophotographic image forming method, specifically, for example, the surface of electrostatic latent image support is charged (charging process) on an by a charging device, an electrostatic latent image (exposure process) that is electrostatically formed through the image exposure is developed by charging the toner particles with the carrier particles in the two-component developer of the present embodiment particles in the developing device, thereby obtaining a visualized toner image (developing step). Thereafter, the toner image is transferred to the paper (transfer step), and the toner image transferred onto the paper is then fixed (fixing process) through a fixing treatment by a contact heating method or the like, thereby obtaining a visible image.

### EXAMPLES

The effect of the invention will be described with reference to the following Examples and Comparative Examples. However, the technical scope of the invention is not limited only to the following Examples.

[Production of Toner Particles]

<Production of Toner Maternal Particles 1>

(Preparation of Colorant Fine Particle Dispersion)

A solution in which 11.5 parts by mass of sodium n-dodecyl sulfate was dissolved in 160 parts by mass of ion-exchanged water by stirring was prepared, and 24.5 parts by mass of copper phthalocyanine (C.I. Pigment Blue 15:3) was gradually added thereto while stirring the solution. Subsequently, the dispersion treatment was conducted using a stirring device “CLEARMIX (registered trademark) W-motion CLM-0.8” (manufactured by M Technique Co., Ltd.), thereby preparing the “colorant fine particle dispersion [A1]” having a median diameter on a volume basis of the colorant fine particles of 126 nm.

(Production of Resin for Core)

(Production of Crystalline Polyester Resin)

Into a three-neck flask, 300 g of 1,9-nonanediol, 250 g of dodecanedioic acid, and Ti(OBu)₄ of the catalyst in an amount to be 0.014% by mass with respect to dodecanedioic acid were put, and the air pressure in the vessel was reduced by vacuum operation. Furthermore, nitrogen gas was used to provide an inert atmosphere, and reflux was conducted for 6 hours at 180° C. by mechanical stirring. Thereafter, the unreacted monomer component was removed by distillation under reduced pressure, the temperature was gradually raised up to 220° C., and the resultant was stirred for 12 hours. Cooling was conducted when the resultant was in a viscous state, thereby obtaining the crystalline polyester resin (B1). The weight average molecular weight (Mw) of the crystalline polyester resin (B1) thus obtained was 19,500, and the melting point thereof was 75° C.

(First Stage Polymerization)

In a 5 L reaction vessel equipped with a stirring device, a temperature sensor, a cooling tube, and a nitrogen introducing device, 4 g of sodium polyoxyethylene (2) dodecyl ether sulfate and 3000 g of ion-exchanged water were put, and the internal temperature of the reaction vessel was raised to 80° C. while stirring the mixture at a stirring speed of 230 rpm in a nitrogen stream. After the temperature was raised, a solution prepared by dissolving 10 g of potassium persulfate in 200 g of ion-exchanged water was added thereto, and the liquid temperature was set to 75° C., a monomer mixed liquid composed of:

Styrene 568 g,

n-butyl acrylate 164 g, and

Methacrylic acid 68 g

was added thereto dropwise over 1 hour, and the polymerization was conducted by heating and stirring for 2 hours at 75° C., thereby preparing a dispersion of resin particles [C1].

(Second Stage Polymerization)

In a 5 L reaction vessel equipped with a stirring device, a temperature sensor, a cooling tube, and a nitrogen introducing device, a solution prepared by dissolving 2 g of sodium polyoxyethylene (2) dodecyl ether sulfate in 3000 g of ion-exchanged water was put. After it was heated to 80° C., 42 g (in terms of solid content) of the dispersion of the resin particles [C1], 70 g of paraffin wax “HNP-0190” (manufactured by the NIPPON SEIRO CO., LTD.) and 70 g of the crystalline polyester resin (B1) were put therein, furthermore, a monomer mixed liquid composed of:

Styrene 195 g,

n-butyl acrylate 91 g,

Methacrylic acid 20 g, and

n-octyl mercaptan 3 g

was added thereto at 80° C. and dissolved. Thereafter, the mixture was mixed and dispersed for 1 hour using a mechanical dispersing machine having a circulation path “CLEARMIX (registered trademark)” (manufactured by M Technique Co., Ltd.), thereby preparing a dispersion containing emulsified particles (oil droplets).

Subsequently, an initiator solution prepared by dissolving 5 g of potassium persulfate in 100 g of ion-exchanged water was added to this dispersion, and the polymerization was conducted by heating and stirring this system for 1 hour at 80° C., thereby preparing a dispersion of the resin particles [C2].

(Third Stage Polymerization)

A solution prepared by dissolving 10 g of potassium persulfate in 200 g of ion-exchanged water was further added to the dispersion of resin particles [C2], a monomer mixed liquid composed of:

Styrene 298 g,

n-butyl acrylate 137 g,

n-stearyl acrylate 50 g,

Methacrylic acid 64 g, and

n-octyl mercaptan 6 g

was added thereto dropwise over 1 hour under a temperature condition of 80° C. After the dropwise addition was ended, the polymerization was conducted by heating and stirring for 2 hours, and the resultant was then cooled to 28° C., thereby obtaining a dispersion of the resin fine particles for core [C3].

(Preparation of Resin for Shell)

In a reaction vessel equipped with a stirring device, a temperature sensor, a cooling tube, and a nitrogen introducing device, a surfactant solution prepared by dissolving 2.0 g of sodium polyoxyethylene dodecyl ether sulfate in 3000 g of ion-exchanged water was put, and the internal temperature of the reaction vessel was raised to 80° C. while stirring the mixture at a stirring speed of 230 rpm in a nitrogen stream.

An initiator solution prepared by dissolving 10 g of potassium persulfate in 200 g of ion-exchanged water was added to this solution, and a polymerizable monomer mixed liquid prepared by mixing the compounds composed of:

Styrene 564 g,

n-butyl acrylate 140 g,

Methacrylic acid 96 g, and

n-octyl mercaptan 12 g

was added thereto dropwise over 3 hours. After the dropwise addition, and the polymerization was conducted by heating and stirring this system for 1 hour at 80° C., thereby preparing a dispersion of the resin fine particles for shell [D1].

(Aggregation and Fusion Step)

In a 5 L reaction vessel equipped with a stirring device, a temperature sensor, a cooling tube, and a nitrogen introducing device, 360 g of the dispersion (in terms of solid content) of the resin fine particles for core [C3], 1100 g of ion-exchanged water, and 50 g of the dispersion (A1) (solid concentration: 25% by mass) of the colorant fine particles were put, the liquid temperature was adjusted to 30° C., the pH was adjusted to 10 by adding a 5 N aqueous solution of sodium hydroxide. Subsequently, an aqueous solution prepared by dissolving 60 g of magnesium chloride in 60 g of ion-exchanged water was added thereto over 10 minutes at 30° C. while stirring. This system was held for 3 minutes, and the temperature thereof was then started to be raised, the temperature of this system was raised up to 85° C. over 60 minutes, and the particle growth reaction was continued while holding the temperature at 85° C. In this state, the particle size of the associated particles was measured using the “Multisizer 3 COULTER COUNTER” (manufactured by Beckman Coulter, Inc.), and the particle growth was stopped by adding an aqueous solution prepared by dissolving 40 g of sodium chloride in 160 g of ion-exchanged water to the system at the time point at which the median diameter on a volume basis reached 3.8 μm, furthermore, the fusion among the particles was progressed by heating and stirring for 1 hour at a liquid temperature of 80° C. as the aging step, thereby forming the core particles (1).

Subsequently, 80 g (in terms of solid content) of the resin fine particles for shell [D1] was added, and the stirring was continued for 1 hour at 80° C. to fuse the resin fine particles for shell [D1] on the surface of the core particles (1), thereby forming the shell layer. Here, an aqueous solution prepared by dissolving 150 g of sodium chloride in 600 g of ion-exchanged water was added thereto and the aging treatment was conducted at 80° C., and the system was started to be cooled at the time point at which the circularity reached 0.966 and cooled to 30° C., thereby obtaining a dispersion of the toner maternal particles 1. The median diameter on a volume basis of the toner after cooling was 4.0 μm, and the circularity thereof was 0.966.

(Washing and Drying Steps)

The dispersion of the toner maternal particles 1 produced in the aggregation and fusion step was subjected to the solid-liquid separation using a centrifuge, thereby forming a wet cake of the toner maternal particles 1. The wet cake was washed with ion-exchanged water at 35° C. until the electric conductivity of the filtrate from the centrifuge reached 5 μS/cm, then moved to the “flash jet dryer” (manufactured by SEISHIN ENTERPRISE Co., Ltd.), and dried until the water content became 0.8% by mass, thereby producing the “toner maternal particles 1”.

<Production of Toner Maternal Particles 2 and 3>

The toner maternal particles 2 and 3 were produced in the same manner as in the <Production of toner maternal particles 1> except that cooling was started at the time point at which the average circularity reached 0.970 (toner maternal particles 2) and 0.975 (toner maternal particles 3), respectively.

<Production of Toner Maternal Particles 4 to 7>

The toner maternal particles 4 to 7 were produced in the same manner as in the <Production of toner maternal particles 1> except that the timing to stop the particle growth by adding an aqueous solution prepared by dissolving 40 g of sodium chloride in 160 g of ion-exchanged water was changed, the median diameter on a volume basis of the toner maternal particles were set to 3.0 μm (toner maternal particles 4), 5.0 μm (toner maternal particles 5), 2.8 μm (toner maternal particles 6), and 5.2 μm (toner maternal particles 7), respectively, and cooling was started at the time point at which the average circularity reached 0.971 (toner maternal particles 4), 0.970 (toner maternal particles 5), 0.972 (toner maternal particles 6), and 0.971 (toner maternal particles 7), respectively.

<Production of Toner Particles 1 to 7>

(External Additive Treatment Step)

The respective “toner maternal particles 1 to 7” produced as described above, and

Sol-gel silica (HMDS treated, hydrophobicity: 72%, number average primary particle size: 130 nm) at 2.0% by mass with respect to the toner maternal particles,

Hydrophobic silica (HMDS treated, hydrophobicity: 72%, number average primary particle size: 40 nm) at 2.5% by mass with respect to the toner maternal particles, and

Hydrophobic titanium oxide (HMDS treated, hydrophobicity: 55%, number average primary particle size: 20 nm) at 0.5% by mass with respect to the toner maternal particles were put in the Henschel mixer Model “FM20C/I” (manufactured by NIPPON COKE & ENGINEERING CO., LTD.) and stirred for 15 minutes by setting the rotational speed so as to have a blade tip peripheral speed of 40 m/s, thereby producing the “toner particles 1 to 7”.

In addition, the product temperature at the time of mixing the external additive was set to 40° C.±1° C., and the control of the internal temperature of the Henschel mixer was conducted by allowing cooling water to flow into the outside bath of the Henschel mixer at a flow rate of 5 L/min when the temperature increased to 41° C. and allowing cooling water to flow into the outside bath of the Henschel mixer at a flow rate of 1 L/min when the temperature decreased to 39° C.

The volume average particle size and the average circularity of the toner particles 1 to 7 thus obtained are presented in the following Table 1. The measurement methods are as follows.

<Volume Average Particle Size of Toner Particles>

The median diameter (D₅₀) on a volume basis of the toner particles can be measured and calculated using an apparatus in which the computer system for data processing is connected to “Multisizer 3 (manufactured by Beckman Coulter, Inc.)”. As the measurement procedure, 0.02 g of the toner particles are mixed with 20 ml of a surfactant solution (for the purpose of dispersing the toner particles, for example, a surfactant solution obtained by diluting a neutral detergent containing a surfactant component 10 times with pure water) thoroughly and evenly, and the mixture is then subjected to the ultrasonic dispersion for 1 minute, thereby preparing a toner particle dispersion. This toner particle dispersion is injected into the beaker containing ISOTON II (manufactured by Beckman Coulter, Inc.) in the sample stand with a pipette until the measurement concentration becomes from 5 to 10%, the count of the measuring machine is set to 25000 times, and the measurement is conducted. Incidentally, the Multisizer 3 having an aperture diameter of 100 μm is used. The number of frequency is calculated by dividing the measurement range of from 1 to 30 μm by 256, and the particle size at 50% from the greater volume cumulative fraction is adopted as the median diameter (D₅₀) on a volume basis.

<Average Circularity of Toner Particles>

The toner particles are wet with an aqueous surfactant solution, subjected to the ultrasonic dispersion for 1 minute to disperse them, and subjected to the measurement at a proper concentration having a HPF detection number of from 3000 to 10000 using a flow type particle image analyzer “FPIA-3000” (manufactured by Sysmex Corporation) under the measurement condition of HPF (high magnification imaging) mode. A measured value exhibiting reproducibility is obtained in this range. The circularity is calculated by the following Equation.

Circularity=(Circumference of circle having the same projected area as particle image)/(Circumference of particle projected image) [Math. 3]

The average circularity is the arithmetic mean value obtained by summing the circularity of each particle and dividing the sum by the total number of the particles measured.

TABLE 1

| | Volume average | |
|---|---|---|
| | particle size (μm) | Average circularity |
| Toner particles 1 | 4.0 | 0.966 |
| Toner particles 2 | 4.0 | 0.970 |
| Toner particles 3 | 4.0 | 0.975 |
| Toner particles 4 | 3.0 | 0.971 |
| Toner particles 5 | 5.0 | 0.970 |
| Toner particles 6 | 2.8 | 0.972 |
| Toner particles 7 | 5.2 | 0.971 |

[Production of Carrier Particles]

(Production of Core Particles 1)

The raw materials were weighed so as to be MnO: 35 mol %, MgO: 14.5 mol %, Fe₂O₃: 50 mol %, and SrO: 0.5 mol %, mixed with water, and then pulverized for 5 hours using a wet media mill, thereby obtaining a slurry.

The slurry thus obtained was dried using a spray dryer to obtain spherical particles. These particles were subjected to the particle size adjustment, heated for 2 hours at 950° C., and calcined in a rotary kiln. The calcined particles were pulverized for 1 hour in a dry ball mill using stainless steel beads with a diameter of 0.3 cm, PVA as the binder was then added thereto at 0.8% by mass with respect to the solid content, water and the dispersing agent were further added thereto, and the resultant was pulverized for 35 hours using zirconia beads with a diameter of 0.5 cm. Subsequently, the resultant was granulated and dried using a spray dryer, and held in an electric furnace at a temperature of 1050° C. for 20 hours to conduct firing.

Thereafter, the fired particles were crushed and classified to adjust the particle size, and the product having a low magnetic strength was then separated by magnetic separation, thereby obtaining the core particles 1. The volume average particle size of the core particles 1 was 14.0 μm.

(Production of Core Particles 2)

The core particles 2 were produced in the same manner as the core particles 1 except that the pulverizing time after calcination was set to 30 hours in the production of the core particles 1.

(Production of Core Particles 3)

The core particles 3 were produced in the same manner as the core particles 1 except that the pulverizing time after calcination was set to 25 hours in the production of the core particles 1.

(Production of Core Particles 4)

The core particles 4 were produced in the same manner as the core particles 2 except that the firing temperature was set to 900° C. in the production of the core particles 2.

(Production of Core Particles 5)

The core particles 5 were produced in the same manner as the core particles 2 except that the firing temperature was set to 1250° C. in the production of the core particles 2.

(Production of Core Particles 6)

The core particles 6 were produced in the same manner as the core particles 2 except that the firing temperature was set to 850° C. in the production of the core particles 2.

(Production of Core Particles 7)

The core particles 7 were produced in the same manner as the core particles 1 except that the firing temperature was set to 1350° C. in the production of the core particles 1.

(Production of Core Particles 8)

The core particles 8 were produced in the same manner as the core particles 1 except that the raw materials were weighed so as to be MnO: 40.0 mol %, MgO: 9.5 mol %, Fe₂O₃: 50 mol %, and SrO: 0.5 mol %, the pulverizing time after calcination was set to 38 hours, and the firing time was set to 25 hours in the production of the core particles 1.

(Production of Core Particles 9)

The core particles 9 were produced in the same manner as the core particles 1 except that the raw materials were weighed so as to be MnO: 30.0 mol %, MgO: 19.5 mol %, Fe₂O₃: 50 mol %, and SrO: 0.5 mol %, the pulverizing time after calcination was set to 23 hours, and the firing time was set to 15 hours in the production of the core particles 1.

(Production of Core Particles 10)

The core particles 10 were produced in the same manner as the core particles 1 except that the raw materials were weighed so as to be MnO: 15.0 mol %, MgO: 34.5 mol %, Fe₂O₃: 50 mol %, and SrO: 0.5 mol %, the pulverizing time after calcination was set to 33 hours, and the firing time was set to 10 hours in the production of the core particles 1.

(Production of Core Particles 11)

The core particles 11 were produced in the same manner as the core particles 1 except that the raw materials were weighed so as to be MnO: 44.5 mol %, MgO: 5.0 mol %, Fe₂O₃: 50 mol %, and SrO: 0.5 mol %, the pulverizing time after calcination was set to 25 hours, and the firing time was set to 30 hours in the production of the core particles 1.

<Shape Factor SF-1 of Core Particles>

The shape factor (SF-1) of the core particles is a numerical value calculated by the following Equation.

[Math. 4]

SF-1=(Maximum length of particle)²/(Projected area of particle)×(n/4)×100 (Equation 1)

(Measurement)

The core particles are randomly photographed for 100 or more particles at a magnification of 150 using a scanning electron microscope, photographic images captured by a scanner are measured using an image processing analyzer LUZEX AP (Nireco Corporation). The number average particle size is calculated as the average value of the Feret's diameters in the horizontal direction, and the shape factor is a value calculated by the average value of the shape factor SF-1 that is calculated by Equation 1.

<Average Magnetization Per One Particle in Applied Magnetic Field of 1 Kilooersted>

The average magnetization σs (AM²/particle) per one particle in an applied magnetic field of 1 kilooersted is represented by the following Equation.

[Math. 5]

σs=σ×4π(r/2)³ρ/(3×10¹⁵) Equation:

σ: Magnetization per weight of core particles (AM²/kg)
r: Volume average particle size of core particles, D50 (μm)
ρ: True specific gravity of core particles (g/cm³)

Here, the magnetization (AM²/kg) of the carrier is the value that is determined in the following manner.

The core particles are measured in a magnetic field of 1 k (10³/4π·A/m)=1 kOe by a BH tracer method using a VSM (vibration sample method) measuring instrument. The measuring instrument used is the vibrating sample magnetometer VSM-C7-10 manufactured by TOEI INDUSTRY CO., LTD.

In addition, as the true specific gravity of the core particles, the value measured by the same method as the true specific gravity of the carrier particles is adopted.

The composition, production conditions, and physical properties of the respective core particles are presented in the following Table 2.

TABLE 2

| | | | | | Pulverizing | | | | | | | | |
|---|---|---|---|---|---|---|---|---|---|---|---|---|---|
| | | | | | time using | | | | | | | | |
| | | | | | zirconia | | | | | Saturation | True | Volume | |
| Core | Composition | | | | beads after | Firing | Firing | Volume | Average | magneti- | specific | average | Shape |
| particles | (% by mole) | | | | calcination | temper- | time | resistivity | magnetization | zation | gravity | particle | factor |
| No. | MnO | MgO | Fe₂O₃ | SrO | (hours ) | ature | (hours) | (Ω · cm) | (AM²/particle) | (AM²/kg) | (g/cm³) | size (μm) | SFI |
| 1 | 35.0 | 14.5 | 50.0 | 0.5 | 35 | 1050° C. | 20 | 5.0 × 10⁸ | 4.4 × 10⁻¹⁰ | 63.2 | 4.8 | 14.0 | 115 |
| 2 | 35.0 | 14.5 | 50.0 | 0.5 | 30 | 1050° C. | 20 | 4.8 × 10⁸ | 1.7 × 10⁻⁹ | 63.2 | 4.8 | 22.0 | 115 |
| 3 | 35.0 | 14.5 | 50.0 | 0.5 | 25 | 1050° C. | 20 | 5.4 × 10⁸ | 3.9 × 10⁻⁹ | 63.2 | 4.8 | 29.0 | 115 |
| 4 | 35.0 | 14.5 | 50.0 | 0.5 | 30 | 900° C. | 20 | 1.1 × 10⁷ | 1.7 × 10⁻⁹ | 63.2 | 4.8 | 22.0 | 110 |
| 5 | 35.0 | 14.5 | 50.0 | 0.5 | 30 | 1250° C. | 20 | 9.8 × 10⁸ | 1.7 × 10⁻⁹ | 63.2 | 4.8 | 22.0 | 120 |
| 6 | 35.0 | 14.5 | 50.0 | 0.5 | 30 | 850° C. | 20 | 9.2 × 10⁶ | 1.7 × 10⁻⁹ | 63.2 | 4.8 | 22.0 | 105 |
| 7 | 35.0 | 14.5 | 50.0 | 0.5 | 30 | 1350° C. | 20 | 5.2 × 10⁹ | 1.7 × 10⁻⁹ | 63.2 | 4.8 | 22.0 | 125 |
| 8 | 40.0 | 9.5 | 50.0 | 0.5 | 38 | 1050° C. | 25 | 6.1 × 10⁸ | 3.9 × 10⁻¹⁰ | 68.1 | 5 | 13.0 | 115 |
| 9 | 30.0 | 19.5 | 50.0 | 0.5 | 23 | 1050° C. | 15 | 5.2 × 10⁸ | 4.2 × 10⁻⁹ | 63.2 | 4.7 | 30.0 | 115 |
| 10 | 15.0 | 34.5 | 50.0 | 0.5 | 33 | 1050° C. | 10 | 4.8 × 10⁸ | 3.2 × 10⁻¹⁰ | 40.0 | 4.5 | 15.0 | 113 |
| 11 | 44.5 | 5.0 | 50.0 | 0.5 | 25 | 1050° C. | 30 | 5.4 × 10⁸ | 5.2 × 10⁻⁹ | 79.0 | 5.2 | 29.0 | 117 |

<Production of Coating Resin>

(Production of Coating Resin 1)

Cyclohexyl methacrylate and methyl methacrylate “mass ratio=50:50” (copolymerization ratio) were added to a 0.3% by mass aqueous solution of sodium benzenesulfonate, and potassium persulfate was added thereto in an amount to be 0.5% by mass of the total amount of the monomers, the mixture was subjected to the emulsion polymerization, and the resultant was dried using a spray dryer, thereby producing the coating resin 1. The weight average molecular weight of the coating resin 1 thus obtained was 500,000.

(Production of Coating Resin 2)

The coating resin 2 was obtained in the same manner as in the production of the coating resin 1 except that styrene was used instead of cyclohexyl methacrylate in the production of the coating resin 1.

<Production of Carrier Particles>

(Production of Carrier Particles 1)

In a high-speed stirring mixer with a horizontal stirring blade, 100 parts by mass of the core particles 1 prepared above as the core particles and 4.5 parts by mass of the coating resin 1 were put, mixed and stirred for 15 minutes at 22° C. under a condition to have a peripheral speed of the horizontal rotor of 8 m/sec, and then mixed for 50 minutes at 120° C. to coat the surface of the core particles with the coating material by the action of a mechanical impact force (mechanochemical method), and the resultant was then cooled to room temperature, thereby producing the “carrier particles 1”.

(Production of Carrier Particles 2)

The carrier particles 2 were produced in the same manner as in the production of carrier particles 1 except that the core particles 2 were used instead of the core particles 1 and the coating resin 2 was used instead of the coating resin 1 in the production of carrier particles 1.

(Production of Carrier Particles 3 to 12)

The carrier particles 3 to 12 were produced in the same manner as in the production of carrier particles 1 except that the core particles presented in Table 3 were used instead of the core particles 1 in the production of carrier particles 1.

(Production of Carrier Particles 13 to 16)

The carrier particles 13 to 16 were produced in the same manner as in the production of carrier particles 3 except that the amount of the coating resin 1 added and the treatment time at 120° C. were changed to those presented in Table 3 in the production of carrier particles 3.

<Volume Average Particle Size of Carrier Particles>

The volume average particle size (D₅₀) of the carrier particles was measured by a wet method using a laser diffraction type particle size distribution measuring apparatus “HEROS KA” (manufactured by Japan Laser Corporation). Specifically, first, an optical system having the focal position of 200 mm is selected, and the measuring time is set to 5 seconds. Thereafter, the magnetic particles for measurement are added to a 0.2% by mass aqueous solution of sodium dodecyl sulfate and dispersed for 3 minutes using a ultrasonic cleaner “US-1” (manufactured by AS ONE Corporation) to prepare a sample dispersion for measurement, several drops of this are supplied to the “HEROS KA”, and the measurement is started when the sample concentration gauge reaches the measurable region. The cumulative distribution of the particle size distribution thus obtained is created with respect to the particle size range (channel) from the small size side, and the particle size at an accumulation of 50% is adopted as the volume average particle size (D₅₀).

(Volume Resistivity of Carrier Particles)

The photoreceptor drum of a commercially available digital full-color multi-function printer “bizhub PRO (registered trademark) C6500” (manufactured by Konica Minolta, Inc.) is replaced with an aluminum electrode drum having the same dimensions as the photoreceptor drum, and the carrier particles are supplied onto the developing sleeve to form a magnetic brush.

This magnetic brush is rubbed with the aluminum electrode drum, a voltage (500 V) is applied between this developing sleeve and the drum and the current flowing through therebetween is measured, and then the volume resistivity (Ω·cm) of the carrier particles can be determined by the following Equation.

[Math. 6]

DVR (Ωcm)=(V/I)×(N×L/Dsd) (2)

DVR: Volume resistivity (Ω·cm)

V: Voltage between developing sleeve and drum (V)

I: Measured current value (A)

N: Developing nip width (contact width of developer formed between developing sleeve (Development roller) and photoreceptor (Photoconductor) (cm)

L: Length of developing sleeve (longitudinal direction) (cm)

Dsd: Distance between developing sleeve and drum (cm)

In the invention, the measurement is conducted at V=500 V, N=1 cm, L=6 cm, and Dsd=0.6 mm.

The constitution and physical properties of the carrier particles are presented in the following Table 3.

TABLE 3

| | | | | | Carrier particles | | |
|---|---|---|---|---|---|---|---|
| | | | | | Volume | | Area of core |
| Carrier | Core | Kind of | | Treatment | average | Volume | particles |
| particles | particles | coating | Amount | time at | particle | resistivity | exposed on |
| No. | No. | resin | of resin | 120° C. | size (μm) | (Ω · cm) | surface (%) |
| 1 | 1 | 1 | 4.5 parts | 50 minutes | 15.0 | 5.0 × 10⁹ | 14.2 |
| 2 | 2 | 2 | 4.5 parts | 50 minutes | 23.0 | 4.8 × 10⁹ | 13.8 |
| 3 | 2 | 1 | 4.5 parts | 50 minutes | 23.0 | 4.8 × 10⁹ | 13.8 |
| 4 | 3 | 1 | 4.5 parts | 50 minutes | 30.0 | 5.4 × 10⁹ | 13.9 |
| 5 | 4 | 1 | 4.5 parts | 50 minutes | 23.0 | 1.1 × 10⁸ | 15.1 |
| 6 | 5 | 1 | 4.5 parts | 50 minutes | 23.0 | 9.8 × 10⁹ | 14.3 |
| 7 | 6 | 1 | 4.5 parts | 50 minutes | 23.0 | 9.2 × 10⁷ | 12.9 |
| 8 | 7 | 1 | 4.5 parts | 50 minutes | 23.0 | 5.2 × 10¹⁰ | 15.5 |
| 9 | 8 | 1 | 4.5 parts | 50 minutes | 14.0 | 6.1 × 10⁹ | 14.8 |
| 10 | 9 | 1 | 4.5 parts | 50 minutes | 31.0 | 5.2 × 10⁹ | 14.6 |
| 11 | 10 | 1 | 4.5 parts | 50 minutes | 16.0 | 4.8 × 10⁹ | 14.5 |
| 12 | 11 | 1 | 4.5 parts | 50 minutes | 30.0 | 5.4 × 10⁹ | 16.1 |
| 13 | 2 | 1 | 5.5 parts | 30 minutes | 23.0 | 4.8 × 10⁹ | 10.1 |
| 14 | 2 | 1 | 5.5 parts | 20 minutes | 23.0 | 4.8 × 10⁹ | 9.5 |
| 15 | 2 | 1 | 3.5 parts | 70 minutes | 23.0 | 4.8 × 10⁹ | 17.9 |
| 16 | 2 | 1 | 3.5 parts | 80 minutes | 23.0 | 4.8 × 10⁹ | 18.2 |

### Example 1

### Production of Developer 1

The toner particles 1 and the carrier particles 1 which were produced as described above were mixed such that the toner concentration was 9% by mass, thereby producing the developer 1. The mixer used was the V-type mixer (manufactured by TOKUJU CORPORATION), and the mixing was conducted at 25° C. for 30 minutes.

### Examples 2 to 8

### Production of Developers 2 to 8

### Comparative Examples 3 to 10

### Production of Developers 19 to 26

The developers 2 to 8 and 19 to 26 were produced in the same manner as in the production of developer 1 except that the combination of the toner particles with the carrier particles was changed to those presented in the following Table 4.

Specifically, the developers were produced in the same manner as in the production of developer 1 except that the carrier particles 1 of the developer 1 were changed to the carrier particles presented in the following Table 4.

### Examples 9 to 12

### Production of Developers 9 to 12

### Comparative Examples 1 and 2

### Production of Developers 17 and 18

The developers 9 to 12 and 17 and 18 were produced in the same manner as in the production of developer 3 except that the combination of the toner particles with the carrier particles was changed to those presented in the following Table 4.

Specifically, the developers were produced in the same manner as in the production of developer 3 except that the toner particles 3 of the developer 3 were changed to the toner particles presented in the following Table 4.

### Examples 13 to 16

### Production of Developers 13 to 16>

The developers 13 to 16 were produced in the same manner as in the production of developer 3 except that the toner concentration was changed to those presented in the following Table 4.

[Evaluation]

The respective developers produced above were sequentially filled in a commercially available digital full-color multi-function printer “bizhub PRO (registered trademark) C6500” (manufactured by Konica Minolta, Inc.) as the evaluation apparatus, and a matter to forma strip-shaped solid image with a printing ratio of 5% as a test image was printed 100,000 copies on A4-size high-quality paper (65 g/m²) in a high temperature and high humidity (30° C., relative humidity: 80% RH) environment.

<Density Unevenness>

After printing 100,000 copies, a full 40% tint image was continuously printed on A4-size recording paper 100 copies. Thereafter, the reflection density of the image of the first sheet and the image of the 100th sheet was measured using the Macbeth reflection densitometer “RD907” (manufactured by X-Rite Inc.), and the image density unevenness was evaluated by the density difference between the first sheet and the 100th sheet. In the present evaluation, it was judged to be acceptable when the density difference is 0.05 or less.

⊙: 0.03 or less
◯: greater than 0.03 and 0.05 or less
X: greater than 0.05

<Image Quality (Graininess GI Value)>

The matter to form a strip-shaped solid image with a printing ratio of 40% was printed 500 copies at the initial stage and after printing 100,000 copies, the gradation pattern with a gradation ratio of 32 stages was printed, and the graininess of this gradation pattern was evaluated according to the following evaluation criteria. For the graininess evaluation, the value of the gradation pattern read by the CCD was subjected to the Fourier transform processing in consideration of the MTF (Modulation Transfer Function) correction, the GI (Graininess Index) value appropriate to the human spectral luminous efficiency was measured, and the maximum GI value was determined. It is more favorable as the GI value is smaller. Incidentally, this GI value is a value that is described in the Japan Image Journal 39 (2), 84•93 (2000). In the present evaluation, it was judged to be acceptable when the GI value is less than 0.195.

⊙: less than 0.170
◯: 0.170 or more and less than 0.195
87: 0.195 or more

<Fogging>

A blank matter was printed after printing 100,000 copies, and the fogging was evaluated by the blank density of the transferred material after printing 100,000 copies. The density at 20 locations on the A4-size transferred material was measured, and the average value thereof was adopted as the blank density. The density was measured using a reflection densitometer “RD-918” (manufactured by X-Rite Inc.). It was judged to be acceptable when the blank density was 0.01 or less.

⊙: 0.005 or less
◯: greater than 0.005 and 0.01 or less
X: greater than 0.01

The constitution and evaluation results of the respective developers are presented in the following Table 4.

TABLE 4-1

| | | Toner particles | | | | Carrier particles | | | | |
|---|---|---|---|---|---|---|---|---|---|---|
| | | | Volume | | | | | | | Volume |
| | | | average | | | | | Average | | average |
| | | Toner | particle | | Toner | Carrier | Core | magnetization | Kind of | particle |
| | Developer | particles | size | | concentration | particles | particles | of carrier core | coating | size |
| | No. | No. | (μm) | Circularity | (% by mass) | No. | No. | (AM²/particle) | resin | (μm) |
| Example 1 | 1 | 3 | 4.0 | 0.975 | 9.0% | 1 | 1 | 4.4 × 10⁻¹⁰ | 1 | 15.0 |
| Example 2 | 2 | 3 | 4.0 | 0.975 | 9.0% | 2 | 2 | 1.7 × 10⁻⁹ | 2 | 23.0 |
| Example 3 | 3 | 3 | 4.0 | 0.975 | 9.0% | 3 | 2 | 1.7 × 10⁻⁹ | 1 | 23.0 |
| Example 4 | 4 | 3 | 4.0 | 0.975 | 9.0% | 4 | 3 | 3.9 × 10⁻⁹ | 1 | 30.0 |
| Example 5 | 5 | 3 | 4.0 | 0.975 | 9.0% | 5 | 4 | 1.7 × 10⁻⁹ | 1 | 23.0 |
| Example 6 | 6 | 3 | 4.0 | 0.975 | 9.0% | 6 | 5 | 1.7 × 10⁻⁹ | 1 | 23.0 |
| Example 7 | 7 | 3 | 4.0 | 0.975 | 9.0% | 13 | 2 | 1.7 × 10⁻⁹ | 1 | 23.0 |
| Example 8 | 8 | 3 | 4.0 | 0.975 | 9.0% | 15 | 2 | 1.7 × 10⁻⁹ | 1 | 23.0 |
| Example 9 | 9 | 1 | 4.0 | 0.966 | 9.0% | 3 | 2 | 1.7 × 10⁻⁹ | 1 | 23.0 |
| Example 10 | 10 | 2 | 4.0 | 0.970 | 9.0% | 3 | 2 | 1.7 × 10⁻⁹ | 1 | 23.0 |
| Example 11 | 11 | 4 | 3.0 | 0.971 | 9.0% | 3 | 2 | 1.7 × 10⁻⁹ | 1 | 23.0 |
| Example 12 | 12 | 5 | 5.0 | 0.970 | 9.0% | 3 | 2 | 1.7 × 10⁻⁹ | 1 | 23.0 |
| Example 13 | 13 | 3 | 4.0 | 0.975 | 8.0% | 3 | 2 | 1.7 × 10⁻⁹ | 1 | 23.0 |
| Example 14 | 14 | 3 | 4.0 | 0.975 | 7.5% | 3 | 2 | 1.7 × 10⁻⁹ | 1 | 23.0 |
| Example 15 | 15 | 3 | 4.0 | 0.975 | 10.0% | 3 | 2 | 1.7 × 10⁻⁹ | 1 | 23.0 |
| Example 16 | 16 | 3 | 4.0 | 0.975 | 11.0% | 3 | 2 | 1.7 × 10⁻⁹ | 1 | 23.0 |

| | Carrier particles | | | | | | | | | |
|---|---|---|---|---|---|---|---|---|---|---|
| | | Area of core | | | | | | | | |
| | Volume | particles | | | Image after continuous printing | | | | | |
| | resistivity | exposed on | Initial image | | Density | | | | | |
| | (Ω · cm) | surface (%) | GI value | | unevenness | | GI value | | Fogging | |
| Example 1 | 5.0 × 10⁹ | 14.2 | 0.12 | ⊙ | 0.04 | ◯ | 0.18 | ◯ | 0.008 | ◯ |
| Example 2 | 4.8 × 10⁹ | 13.8 | 0.13 | ⊙ | 0.04 | ◯ | 0.18 | ◯ | 0.007 | ◯ |
| Example 3 | 4.8 × 10⁹ | 13.8 | 0.1 | ⊙ | 0.01 | ⊙ | 0.11 | ⊙ | 0.005 | ⊙ |
| Example 4 | 5.4 × 10⁹ | 13.9 | 0.16 | ⊙ | 0.05 | ◯ | 0.17 | ◯ | 0.009 | ◯ |
| Example 5 | 1.1 × 10⁸ | 15.1 | 0.12 | ⊙ | 0.05 | ◯ | 0.16 | ⊙ | 0.008 | ◯ |
| Example 6 | 9.8 × 10⁹ | 14.3 | 0.18 | ◯ | 0.05 | ◯ | 0.19 | ◯ | 0.009 | ◯ |
| Example 7 | 4.8 × 10⁹ | 10.1 | 0.18 | ◯ | 0.05 | ◯ | 0.19 | ◯ | 0.009 | ◯ |
| Example 8 | 4.8 × 10⁹ | 17.9 | 0.12 | ⊙ | 0.05 | ◯ | 0.16 | ⊙ | 0.008 | ◯ |
| Example 9 | 4.8 × 10⁹ | 13.8 | 0.13 | ⊙ | 0.03 | ⊙ | 0.15 | ⊙ | 0.007 | ◯ |
| Example 10 | 4.8 × 10⁹ | 13.8 | 0.12 | ⊙ | 0.02 | ⊙ | 0.14 | ⊙ | 0.006 | ◯ |
| Example 11 | 4.8 × 10⁹ | 13.8 | 0.18 | ◯ | 0.05 | ◯ | 0.19 | ◯ | 0.009 | ◯ |
| Example 12 | 4.8 × 10⁹ | 13.8 | 0.18 | ◯ | 0.05 | ◯ | 0.19 | ◯ | 0.009 | ◯ |
| Example 13 | 4.8 × 10⁹ | 13.8 | 0.16 | ⊙ | 0.04 | ◯ | 0.16 | ⊙ | 0.008 | ◯ |
| Example 14 | 4.8 × 10⁹ | 13.8 | 0.18 | ◯ | 0.04 | ◯ | 0.18 | ◯ | 0.008 | ◯ |
| Example 15 | 4.8 × 10⁹ | 13.8 | 0.16 | ⊙ | 0.04 | ◯ | 0.18 | ◯ | 0.007 | ◯ |
| Example 16 | 4.8 × 10⁹ | 13.8 | 0.18 | ◯ | 0.04 | ◯ | 0.18 | ◯ | 0.008 | ◯ |

TABLE 4-2

| | | Toner particles | | | | Carrier particles | | | |
|---|---|---|---|---|---|---|---|---|---|
| | | | Volume | | | | | | Volume |
| | | | average | | | | | Average | average |
| | | Toner | particle | | Toner | Carrier | Core | magnetization | particle |
| | Developer | particles | size | | concentration | particles | particles | of carrier core | size |
| | No. | No. | (μm) | Circularity | (% by mass) | No. | No. | (AM²/particle) | (μm) |
| Comparative | 17 | 6 | 2.8 | 0.972 | 9.0% | 3 | 2 | 1.7 × 10⁻⁹ | 23.0 |
| Example 1 | | | | | | | | | |
| Comparative | 18 | 7 | 5.2 | 0.971 | 9.0% | 3 | 2 | 1.7 × 10⁻⁹ | 23.0 |
| Example 2 | | | | | | | | | |
| Comparative | 19 | 3 | 4.0 | 0.975 | 9.0% | 7 | 6 | 1.7 × 10⁻⁹ | 23.0 |
| Example 3 | | | | | | | | | |
| Comparative | 20 | 3 | 4.0 | 0.975 | 9.0% | 8 | 7 | 1.7 × 10⁻⁹ | 23.0 |
| Example 4 | | | | | | | | | |
| Comparative | 21 | 3 | 4.0 | 0.975 | 9.0% | 9 | 8 | 3.9 × 10⁻¹⁰ | 14.0 |
| Example 5 | | | | | | | | | |
| Comparative | 22 | 3 | 4.0 | 0.975 | 9.0% | 10 | 9 | 4.2 × 10⁻⁹ | 31.0 |
| Example 6 | | | | | | | | | |
| Comparative | 23 | 3 | 4.0 | 0.975 | 9.0% | 11 | 10 | 3.2 × 10⁻¹⁰ | 16.0 |
| Example 7 | | | | | | | | | |
| Comparative | 24 | 3 | 4.0 | 0.975 | 9.0% | 12 | 11 | 5.2 × 10⁻⁹ | 30.0 |
| Example 8 | | | | | | | | | |
| Comparative | 25 | 3 | 4.0 | 0.975 | 9.0% | 14 | 2 | 1.7 × 10⁻⁹ | 23.0 |
| Example 9 | | | | | | | | | |
| Comparative | 26 | 3 | 4.0 | 0.975 | 9.0% | 16 | 2 | 1.7 × 10⁻⁹ | 23.0 |
| Example 10 | | | | | | | | | |

| | Carrier particles | | | | | | | | | |
|---|---|---|---|---|---|---|---|---|---|---|
| | | Area of core | | | | | | | | |
| | Volume | particles | | | Image after continuous printing | | | | | |
| | resistivity | exposed on | Initial image | | Density | | | | | |
| | (Ω · cm) | surface (%) | GI value | | unevenness | | GI value | | Fogging | |
| Comparative | 4.8 × 10⁹ | 13.8 | 0.2 | X | 0.05 | ◯ | 0.21 | X | 0.01 | ◯ |
| Example 1 | | | | | | | | | | |
| Comparative | 4.8 × 10⁹ | 13.8 | 0.22 | X | 0.05 | ◯ | 0.22 | X | 0.01 | ◯ |
| Example 2 | | | | | | | | | | |
| Comparative | 9.2 × 10⁷ | 12.9 | 0.18 | ◯ | 0.05 | ◯ | 0.21 | X | 0.011 | X |
| Example 3 | | | | | | | | | | |
| Comparative | 5.2 × 10¹⁰ | 15.5 | 0.22 | X | 0.05 | ◯ | 0.22 | X | 0.01 | ◯ |
| Example 4 | | | | | | | | | | |
| Comparative | 6.1 × 10⁹ | 14.8 | 0.18 | ◯ | 0.05 | ◯ | 0.21 | X | 0.011 | X |
| Example 5 | | | | | | | | | | |
| Comparative | 5.2 × 10⁹ | 14.6 | 0.22 | X | 0.05 | ◯ | 0.22 | X | 0.01 | ◯ |
| Example 6 | | | | | | | | | | |
| Comparative | 4.8 × 10⁹ | 14.5 | 0.18 | ◯ | 0.05 | ◯ | 0.21 | X | 0.011 | X |
| Example 7 | | | | | | | | | | |
| Comparative | 5.4 × 10⁹ | 16.1 | 0.15 | ⊙ | 0.05 | ◯ | 0.22 | X | 0.012 | X |
| Example 8 | | | | | | | | | | |
| Comparative | 4.8 × 10⁹ | 9.5 | 0.22 | X | 0.05 | ◯ | 0.22 | X | 0.01 | ◯ |
| Example 9 | | | | | | | | | | |
| Comparative | 4.8 × 10⁹ | 18.2 | 0.18 | ◯ | 0.05 | ◯ | 0.21 | X | 0.011 | X |
| Example 10 | | | | | | | | | | |

As can be seen from Table 4, it has been found that the initial GI value is low, the fogging is decreased even after continuous printing, excellent dot reproducibility is exhibited, and a high-quality image is obtained in the case of using the two-component developers of Examples. From this fact, it has been found that a high-quality image is obtained for a long period of time as the two-component developer of the invention is used.

On the other hand, poor developing property is exhibited at the initial printing and after continuous printing or after continuous printing in Comparative Examples 1 and 2 having a deviated volume average particle size of the toner particles, Comparative Examples 3 and 4 having a deviated volume resistivity of the carrier particles, Comparative Examples 5 and 6 having a deviated volume average particle size of the carrier particles, Comparative Examples 7 and 8 having a deviated average magnetization of the carrier core particles, and Comparative Examples 9 and 10 having a deviated exposed area of the core particles.

What is claimed is:

1. A two-component developer for developing an electrostatic latent image comprising:
toner particles; and
carrier particles having a core particle surface coated with a coating resin; wherein
a volume average particle size of the toner particles is 3.0 μm or more and 5.0 μm or less,
an average magnetization of the core particle per one particle in an applied magnetic field of 1 kilooersted is 3.5×10⁻¹⁰ AM²/particle or more and 5.0×10⁻⁹ AM²/particle or less,
a volume average particle size of the carrier particles is 15.0 μm or more and 30.0 μm or less,
a volume resistivity is 1.0×10⁸ Ω·cm or more and 5.0×10¹⁰ Ω·cm or less, and
an area ratio of the core particles exposed on the carrier particle surface is 10.0% or more and 18.0% or less.

2. The two-component developer for developing an electrostatic latent image according to claim 1, wherein the coating resin contains a constitutional unit derived from an alicyclic (meth)acrylic acid ester.

3. The two-component developer for developing an electrostatic latent image according to claim 1, wherein a ratio of the toner particles to a sum of the carrier particles and the toner particles is from 8.0 to 10.0% by mass.

4. The two-component developer for developing an electrostatic latent image according to claim 1, wherein the toner particles contain at least a crystalline polyester resin.

5. The two-component developer for developing an electrostatic latent image according to claim 1, wherein an average circularity of the toner particles is 0.970 or more.

6. The two-component developer for developing an electrostatic latent image according to claim 1, wherein the volume average particle size of the toner particles is 3.5 μm or more and 4.5 μm or less.

7. The two-component developer for developing an electrostatic latent image according to claim 1, wherein the average magnetization of the core particle per one particle in an applied magnetic field of 1 kilooersted is 4.0×10⁻¹⁰ AM²/particle or more and 4.0×10⁻⁹ AM²/particle or less.

8. The two-component developer for developing an electrostatic latent image according to claim 1, wherein the average magnetization of the core particle per one particle in an applied magnetic field of 1 kilooersted is 2.0×10⁻¹⁰ AM²/particle or more and 2.0×10⁻⁹ AM²/particle or less.

9. The two-component developer for developing an electrostatic latent image according to claim 1, wherein the volume average particle size of the carrier particles is 15.0 μm or more and 28.0 μm or less.

10. The two-component developer for developing an electrostatic latent image according to claim 1, wherein the volume average particle size of the carrier particles is 20.0 μm or more and 25.0 μm or less.

11. The two-component developer for developing an electrostatic latent image according to claim 1, wherein the volume resistivity of the carrier particles is 1.0×10⁸ Ω·cm or more and 1.0×10¹⁰ Ω·cm or less.

12. The two-component developer for developing an electrostatic latent image according to claim 1, wherein the volume resistivity of the carrier particles is 1.0×10⁸ Ω·cm or more and 6.0×10⁹ Ω·cm or less.

13. The two-component developer for developing an electrostatic latent image according to claim 1, wherein the area ratio of the core particles exposed on the carrier particle surface is 10.5% or more and 18.0% or less.

14. The two-component developer for developing an electrostatic latent image according to claim 1, wherein the area ratio of the core particles exposed on the carrier particle surface is 12.0% or more and 18.0% or less.
